(19) United States
(12) Patent Application Publication
(10) Pub. No.: US 2026/0351554 A1
(43) Pub. Date: Nov. 5, 2026

(54) CARBON-POLYMER FILMS FOR LITHIUM METAL BATTERIES

(71) Applicant: The Regents of the University of California, Oakland, CA (US)

(72) Inventors: Ping Liu, Oakland, CA (US); Sicen Yu, Oakland, CA (US)

(21) Appl. No.: 19/637,935

(22) Filed: Apr. 2, 2026

Related U.S. Application Data
(63) Continuation of application No. PCT/US2024/050138, filed on Oct. 4, 2024.
(60) Provisional application No. 63/588,181, filed on Oct. 5, 2023.
(60) Provisional application No. 63/568,053, filed on Mar. 21, 2024.

(51) Int. Cl. H01M 4/04; H01M 4/02; H01M 4/134; H01M 4/1395; H01M 4/62; H01M 10/052

(52) U.S. Cl. CPC H01M 4/0452; H01M 4/134; H01M 4/1395; H01M 4/623; H01M 4/625; H01M 10/052; H01M 2004/027

(57) ABSTRACT

Carbon-polymer films for lithium metal batteries are disclosed herein. In one exemplary implementation, a carbon-polymer film can include carbon particles and one or more polymers, in which the carbon particles are present in the film in an amount of about 30 weight percent or lower and the carbon particles have a I_{D}/I_{G} ratio of about 1 or greater, and in which at least a portion of the total amount of carbon particles are present at an outer-most surface of the film. The anode includes a plurality of faceted lithium seeds, in which the plurality of faceted lithium seeds are on a surface of exposed carbon defects of the carbon particles present at the outer-most surface of film. Negative electrodes and lithium metal batteries that include the carbon-polymer film(s) are also disclosed. Methods of manufacturing the negative electrodes and the lithium metal batteries are also disclosed.

### CROSS-REFERENCE TO RELATED APPLICATIONS

The present application claims priority to U.S. Provisional Patent Application No. 63/568,053 filed Mar. 21, 2024, entitled “NEW SUBSTRATES FOR LITHIUM METAL BATTERIES,” and to U.S. Provisional Patent Application No. 63/588,181 filed Oct. 5, 2023, entitled “NEW SUBSTRATES FOR LITHIUM METAL BATTERIES,” the disclosures of which are incorporated by reference herein in their entireties.

### STATEMENT OF GOVERNMENT SPONSORED SUPPORT

This invention was made with government support under DE-EE0007764 awarded by the United States Department of Energy. The government has certain rights in the invention.

### TECHNICAL FIELD

Carbon-polymer films and their application in electrodes and in lithium metal batteries (LMBs) are provided.

### BACKGROUND

Lithium-metal batteries (LMBs) promise high theoretical energy density, but still suffer from short cycle life due to the low reversibility and pulverization of electrodeposited Lithium (Li). Li electrodeposition can be divided into two stages: nucleation and growth. Various methods have been developed to reduce Li pulverization during growth, including the construction of a LiF-rich solid-electrolyte interphase (SEI) layer, utilization of 3D current collectors, and the application of high pressure. However, even under high pressure, the lower layer of electrodeposited Li near the film remains porous compared to the upper layer. Further, recent research suggests that pulsed electrodeposition at ultra-high current densities (>100 mA cm−2) promotes uniform and dendrite-free nucleation. However, the practicality of the pulsed electrodeposition strategy using these extreme parameters is questionable.

Accordingly, there remains a need for improved lithium-metal batteries with long cycle life.

### SUMMARY

Aspects of the current subject matter relate inter alia to electrodes and lithium metal batteries using the same.

Lithium metal batteries are disclosed herein. In one exemplary implementation, a lithium metal battery can include a cathode, a negative current collector, an anode, one or more separators positioned between the anode and the cathode, and one or more electrolytes, in which an amount of the one or more electrolytes is positioned between the cathode and at least one separator of the one or more separators and another amount of the one or more electrolytes is positioned between the anode and the at least one separator of the one or more separators. The negative current collector includes a carbon-polymer film, the film includes carbon particles and one or more polymers, in which the carbon particles are present in the film in an amount of about 30 weight percent or lower and the carbon particles have a ID/IG ratio of about 1 or greater, and in which at least a portion of the total amount of carbon particles are present at an outer-most surface of the film. The anode includes a plurality of faceted lithium seeds, in which the plurality of faceted lithium seeds are on a surface of exposed carbon defects of the carbon particles present at the outer-most surface of film.

Negative electrodes are also disclosed herein. In one exemplary implementation, the negative electrode includes a carbon-polymer film that includes carbon particles and one or more polymers, in which the carbon particles are present in the film in an amount of about 30 weight percent or lower and the carbon particles have a I_{D}/I_{G} ratio of about 1 or greater, and at least a portion of the total amount of carbon particles are present at an outer-most surface of the film. The negative electrode also includes a plurality of faceted lithium seeds on a surface of exposed carbon defects of the carbon particles present at the outer-most surface of film.

Methods of manufacturing negative electrodes are also disclosed herein. In one exemplary implementation, the method can include mixing carbon particles, one or more polymers, and one or more solvents to form a slurry, drying the slurry to remove the one or more solvents to form a carbon-polymer film, in which the carbon particles are present in the film in an amount of about 30 weight percent or lower and the carbon particles have a I_{D}/I_{G} ratio of about 1 or greater; and at least a portion of the total amount of carbon particles are present at an outer-most surface of the film; and exposing the film to electrical current such that a plurality of faceted lithium seeds nucleate on a surface of exposed carbon defects of the carbon particles present at the outer-most surface of the film.

Methods of manufacturing lithium metal batteries are also disclosed herein. In one exemplary implementation, the method can include providing a negative current collector, providing a cathode on a positive current collector, applying one or more electrolytes to a separator; positioning a first surface of a separator adjacent to the cathode, in which an amount of the one or more electrolytes is positioned between the separator and the cathode, positioning the negative current collector adjacent a second, opposing surface of the separator; in which another amount of the one or more electrolytes is positioned between the separator and the negative current collector. The negative current collector includes a carbon-polymer film that includes carbon particles and one or more polymers, in which the carbon particles are present in the film in an amount of about 5 weight percent or greater and the carbon particles have a I_{D}/I_{G} ratio of about 1 or greater; and at least a portion of the total amount of carbon particles are present at an outer-most surface of the film. The method also includes exposing the negative current collector to electrical current such that a plurality of faceted lithium seeds nucleate on a surface of exposed carbon defects of the carbon particles present at the outer-most surface of the film.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

### BRIEF DESCRIPTION OF THE DRAWINGS

The accompanying drawings, which are incorporated into and constitute a part of this specification, show certain aspects of the subject matter disclosed herein and, together with the description, help explain some of the principles associated with the disclosed aspects. In the drawings:

FIG. 1A is a schematic of an exemplary carbon-polymer film on a copper foil, consistent with implementations of the current subject matter, showing defect-mediated lithium deposition on an outer-most surface of the film.

FIG. 1B is a scanning electron microscopy (SEM) image of a carbon-polymer film coated onto copper foil, consistent with implementations of the current subject matter, in which the left insert shows an optical image of the film blade casted onto the copper foil.

FIG. 1C illustrate SEM images of lithium crystals deposited on the film of FIG. 1B, where lithium was deposited at a constant current of 3 mA cm⁻² and a capacity of 0.1 mAh cm⁻².

FIG. 2A illustrates raman spectra of five carbon materials, graphite (G), graphene (Gr), super P (SP), ketjen black (KB), and carbon nanotube (CNT), featuring different D band to G band intensity ratios (i.e., concentrations of defects).

FIG. 2B are SEM images of lithium nucleation on a film coated on a copper foil, consistent with implementations of the current subject matter, the film containing 20 percent weight of graphite (G).

FIG. 2C are SEM images of lithium nucleation on a film coated on a copper foil, consistent with implementations of the current subject matter, the film containing 20 percent weight of graphene (Gr).

FIG. 2D are SEM images of lithium nucleation on a film coated on a copper foil, consistent with implementations of the current subject matter, the film containing 20 percent weight of super P (SP).

FIG. 2E are SEM images of lithium nucleation on a film coated on a copper foil, consistent with implementations of the current subject matter, the film containing 20 percent weight of ketjen black (KB).

FIG. 2F are SEM images of lithium nucleation on a film coated on a copper foil, consistent with implementations of the current subject matter, the film containing 20 percent weight of carbon nanotube (CNT).

FIG. 2G are graphs illustrating size distribution of Li seeds shown in FIGS. 2B-2F, where lithium was deposited at a constant current of 3 mA cm⁻² and a capacity of 0.1 mAh cm⁻²

FIG. 3A is a raman spectra of graphene (Gr) before milling and after ball milling (GrB).

FIG. 3B is an SEM image of Li seeds on a film coated on a copper foil, consistent with consistent with implementations of the current subject matter, where the film contains 20 weight percent of graphene before milling.

FIG. 3C is an SEM image of Li seeds on a film coated onto a copper foil, consistent with consistent with implementations of the current subject matter, where the film contains 20 weight percent of graphene after milling.

FIG. 3D is a raman spectra of Super P (SP) before milling and after annealing (SPA).

FIG. 3E is an SEM image of Li seeds on a film coated on a copper foil, consistent with consistent with implementations of the current subject matter, where the film contains 20 weight percent of SP before milling.

FIG. 3F is an SEM image of Li seeds on a film coated on a copper foil, consistent with implementations of the current subject matter, where the film contains 20 weight percent of SP after milling.

FIG. 3G is C-AFM image a film coated on copper foil, consistent with implementations of the current subject matter, where the film contains containing 5 weight percent of ketjen black.

FIG. 3H is C-AFM image a film coated on copper foil, consistent with implementations of the current subject matter, where the film contains containing 20 weight percent of ketjen black.

FIG. 3I is C-AFM image a film coated on copper foil, consistent with implementations of the current subject matter, where the film contains containing 30 weight percent of ketjen black.

FIG. 3J is C-AFM image a film coated on copper foil, consistent with implementations of the current subject matter, where the film contains containing 50 weight percent of ketjen black.

FIG. 3K is a SEM image of Li deposited on films of FIG. 3G, where lithium was deposited at a constant current of 3 mA cm⁻² and a capacity of 0.1 mAh cm⁻².

FIG. 3L is a SEM image of Li deposited on films of FIG. 3H, where lithium was deposited at a constant current of 3 mA cm⁻² and a capacity of 0.1 mAh cm⁻².

FIG. 3M is a SEM image of Li deposited on films of FIG. 3I, where lithium was deposited at a constant current of 3 mA cm⁻² and a capacity of 0.1 mAh cm⁻².

FIG. 3N is a SEM image of Li deposited on films of FIG. 3J, where lithium was deposited at a constant current of 3 mA cm⁻² and a capacity of 0.1 mAh cm⁻².

FIG. 3O is a graph of a model showing a gap between carbon particles as a function of carbon loading of a film consistent with implementations of the current subject matter, which leads to different lithium nucleation behavior as depicted by the schematic diagrams in the graph.

FIG. 4A is an SEM image of lithium deposition on a film coated on a copper foil, consistent with the implementations of the current subject matter, the film having 20 weight percent of ketjen black, where the lithium was deposited at a constant current of 3 mA cm⁻² and a capacity of 0 V.

FIG. 4B is an SEM image of lithium deposition on a film coated on a copper foil, consistent with the implementations of the current subject matter, the film having 20 weight percent of ketjen black, where the lithium was deposited at a constant current of 3 mA cm⁻² and a capacity of 0.01 mAh cm⁻².

FIG. 4C is an SEM image of lithium deposition on a film coated on a copper foil, consistent with the implementations of the current subject matter, the film having 20 weight percent of ketjen black, where the lithium was deposited at a constant current of 3 mA cm⁻² and a capacity of 0.1 mAh cm⁻².

FIG. 4D is an SEM image of lithium deposition on a film coated on a copper foil, consistent with the implementations of the current subject matter, the film having 20 weight percent of ketjen black, where the lithium was deposited at a constant current of 3 mA cm⁻² and a capacity of 1 mAh cm⁻².

FIG. 4E illustrates an ex-situ raman spectra of a film coated on a copper foil, consistent with implementations of the current subject matter, the film having 20 weight percent of ketjen black at different stages of lithium deposition (OCV: open circuit voltage; OV: biased at OV before lithium deposition), where the lithium was deposited at a constant current of 3 mA cm⁻² and at a capacity of 0.01 mAh cm⁻², at a second capacity of 0.1 mAh cm⁻², and at a third capacity of 1 mAh cm⁻².

FIG. 4F is a schematic diagram of lithium nucleation grown on the film of FIG. 4E prior to lithium deposition and at each stage of lithium deposition in FIG. 4E.

FIG. 5A is a graph that shows coulombic efficiency as a function of cycle number at different current densities on a film coated on a copper foil, consistent with implementation of the current subject matter, where the film contains includes 5 percent weight of super P.

FIG. 5B is a top view SEM image of the film of FIG. 5A, after the 1^{st} deposition of lithium onto the film.

FIG. 5C is a top view SEM image of the film of FIG. 5A, after the 20^{th} deposition of lithium onto the film.

FIG. 5D is a cross-sectional SEM image of the film of FIG. 5C.

FIG. 5E is a graph that shows coulombic efficiency as a function of cycle number at different current densities on a film coated on a copper foil, consistent with implementation of the current subject matter, where the film contains 5 percent weight of ketjen black.

FIG. 5F is a top view SEM image of the film of FIG. 5E, after the 1^{st} deposition lithium onto the film.

FIG. 5G is a top view SEM image of the film shown FIG. 5E, after the 20^{th} deposition lithium onto the film.

FIG. 5H is a cross-sectional SEM image of the film of FIG. 5G.

FIG. 6A is a graph illustrating the capacity retention of two cells, where the first cell included an commercial 20 μm Li foil on a copper film, and a second cell that included lithium deposited on a carbon-polymer film with 20 weight percent of ketjen black, consistent with implementations of the current subject matter.

FIG. 6B is a graph illustrating a voltage profile for each of the two cells of FIG. 6B.

FIG. 6C is a cross-sectional SEM image of the commercial lithium foil of the first cell, after 20 cycles, where the copper foil was delaminated.

FIG. 6D is a cross-sectional SEM image of the film of the second cell, after 20 cycles.

FIG. 7A is an SEM image of faceted Li seeds on an exemplary film consistent with implementations of the current subject matter, where the Li crystals deposited at a constant current density of 0.5 mA cm⁻², the exemplary film including 20 weight percent of ketjen black.

FIG. 7B is an SEM image of faceted Li seeds on an exemplary film consistent with implementations of the current subject matter, where the Li crystals deposited at a constant current density of 3 mA cm⁻², the exemplary film including 20 weight percent of ketjen black.

FIG. 7C is an SEM image of faceted Li seeds on an exemplary film consistent with implementations of the current subject matter, where the Li crystals deposited at a constant current density of 10 mA cm⁻², the exemplary film including 20 weight percent of ketjen black.

FIG. 7D is an SEM image of one of the faceted Li seeds on the exemplary film of FIG. 7A.

FIG. 7E is an SEM image of a portion of the faceted Li seeds on the exemplary film of FIG. 7B.

FIG. 7F is an SEM image of a portion of the faceted Li seeds on the exemplary film of FIG. 7A.

FIG. 8A is an SEM image of Li nucleation on a copper foil, where Li was deposited on the copper foil at a constant current of 3 mA cm⁻² and a capacity of 0.1 mAh cm⁻².

FIG. 8B is another SEM image of a portion of the lithium nucleation on the copper foil of FIG. 8A.

FIG. 9A is an SEM image of a Li seeds deposited on a copper foil, where Li seeds were deposited at a constant current of 3 mA cm⁻² and a capacity of 0.1 mAh cm⁻².

FIG. 9B is an SEM image of a carbon-polymer film, consistent with implementations of the current subject matter, where lithium seeds were deposited at a constant current of 3 mA cm⁻² and a capacity of 0.1 mAh cm⁻².

FIG. 10A is a SEM image of a sample of graphite.

FIG. 10B is TEM image of the sample of graphite of FIG. 10A.

FIG. 10C is TEM image of a portion of the sample of graphite of FIG. 10B.

FIG. 10D is a SEM image of a sample of graphene.

FIG. 10E is TEM image of the sample of graphene of FIG. 10D.

FIG. 10F is TEM image of a portion of the sample of graphene of FIG. 10E.

FIG. 10G is a SEM image of a sample of super P carbon black.

FIG. 10H is TEM image of the sample of super P carbon black of FIG. 10G.

FIG. 10I is TEM image of a portion of the sample of super P carbon black of FIG. 10H.

FIG. 10J is a SEM image of a sample of ketjen black.

FIG. 10K is TEM image of the sample of ketjen black of FIG. 10J.

FIG. 10L is TEM image of a portion of the sample of ketjen black of FIG. 10K.

FIG. 10M is a SEM image of a sample of multi-walled carbon nanotubes.

FIG. 10N is TEM image of the sample of multi-walled carbon nanotubes of FIG. 10M.

FIG. 10O is TEM image of a portion of the sample of multi-walled carbon nanotubes of FIG. 10N.

FIG. 11A are optical images of a graphite (G) pellet, a graphene (Gr) pellet, a super P (SP) pellet, a ketjen black (KB) pellet, and a carbon nanotube (CNT) pellet.

FIG. 11B are optical images of molten lithium on the pellets of FIG. 11A.

FIB. 11C is a graph of contact angles of molten Li for the pellets of FIG. 11B.

FIG. 12A is a graph showing carbon particle size of graphite (G), graphene (Gr), super P (SP), ketjen black (KB), and carbon nanotube (CNT).

FIG. 12B is a graph showing the surface area of graphite (G), graphene (Gr), super P (SP), ketjen black (KB), and carbon nanotube (CNT).

FIG. 13A illustrates XRD profiles of graphite (G), graphene (Gr), super P (SP), ketjen black (KB), and carbon nanotube (CNT).

FIG. 13B illustrates the full width at half maximum (FWHM) of the (002) peak of the same carbons of FIG. 13A.

FIG. 14A is an SEM image of a carbon-polymer film consistent with implementations of the current subject matter, where the film includes 20 percent weight of graphite (G).

FIG. 14B is an SEM image of a carbon-polymer film consistent with implementations of the current subject matter, where the film includes 20 percent weight of graphene (Gr).

FIG. 14C is an SEM image of a carbon-polymer film consistent with implementations of the current subject matter, where the film includes 20 percent weight of super P (SP).

FIG. 14D is an SEM image of a carbon-polymer film consistent with implementations of the current subject matter, where the film includes 20 percent weight of ketjen black (KB).

FIG. 14E is an SEM image of a carbon-polymer film consistent with implementations of the current subject matter, where the film includes 20 percent weight of carbon nanotube (CNT).

FIG. 15 is a graph illustrating the median size and the standard deviation of the Li seed size of the film of FIG. 2B, of the film of FIG. 2C, of the film of FIG. 2D, of the film of FIG. 2E, and of the film of FIG. 2F.

FIG. 16A is a graph of capacity-voltage curves of Li|carbon-polymer film cells, consistent with implementations of the current subject.

FIG. 16B is a graph of capacity-voltage curves of Li|carbon-polymer film cells, consistent with implementations of the current subject.

FIG. 16C illustrates lithiation capacities of carbon particles of the polymer-carbon films of the Li|carbon-polymer film cells of FIG. 16A.

FIG. 16D illustrates the nucleation overpotentials of lithium on the polymer-carbon films of FIG. 16B.

FIG. 17A is a graph showing a regression curve of the standard deviation of Li seed sizes with I_{D}/I_{G} ratios of different types of carbons.

FIG. 17B is a graph showing a regression curve of the standard deviation of Li seed sizes with carbon particle size of different types of carbons.

FIG. 17C is a graph showing a regression curve of the standard deviation of Li seed sizes with wetting of molten Li on different types of carbons.

FIG. 17D is a graph showing a regression curve of the standard deviation of Li seed sizes with FWHM of carbon (200) peak of different types of carbons.

FIG. 17E is a graph showing a regression curve of the standard deviation of Li seed sizes with surface area of carbon of carbon-polymer films of different carbons.

FIG. 17F is a graph showing a regression curve of the standard deviation of Li seed sizes with capacity of carbon-polymer films consistent with implementations of the current subject matter.

FIG. 17G is a graph showing a regression curve of the standard deviation of Li seed sizes with overpotential of Li nucleation on carbon-polymer films consistent with implementations of the current subject matter.

FIG. 17H is a graph showing the coefficient of correlation (R²) of variables of FIGS. 17A-17G on the uniformity of Li seed size.

FIG. 18A is a top-view SEM image of a carbon-polymer film, consistent with implementations of the current subject matter, where the film includes 5 percent weight of ketjen black.

FIG. 18B is a top-view SEM image of a carbon-polymer film, consistent with the implementations of the current subject matter, where the film includes 20 percent weight of ketjen black.

FIG. 18C is a top-view SEM image of a carbon-polymer film consistent, with implementations of the current subject matter, where the film includes 30 percent weight of ketjen black.

FIG. 18D is a top-view SEM image of a carbon-polymer film, consistent with implementations of the current subject matter, where the film includes 50 percent weight of ketjen black.

FIG. 18E is a cross-sectional view SEM image of the film of FIG. 18A.

FIG. 18F is a cross-sectional view SEM image the film of FIG. 18B.

FIG. 18G is a cross-sectional view SEM image of the film of FIG. 18C.

FIG. 18H is a cross-sectional view SEM image of the film of FIG. 18D.

FIG. 19A are TEM images of a carbon-polymer film consistent with the implementation 20 percent weight of ketjen black.

FIG. 19B is a HAADF (high-angle annular dark-field imaging) of the carbon-polymer film of FIG. 19A.

FIG. 19C is a carbon EDS mapping of the carbon-polymer film of FIG. 19A.

FIG. 19D is a fluorine EDS mapping of the carbon-polymer film of FIG. 19A.

FIG. 20A is an SEM image of a carbon-polymer film consistent with implementations of the current subject matter, where the film includes 20 percent weight of ketjen black and lithium was deposited on the film at a current density of 3 mA cm⁻² and at a capacity of 0.05 mAh cm⁻².

FIG. 20B is an SEM image of a carbon-polymer film consistent with implementations of the current subject matter, where the film includes 20 percent weight of ketjen black and lithium was deposited on the film at a current density of 3 mA cm⁻² and a capacity of 0.1 mAh cm⁻².

FIG. 20C is an SEM image of a carbon-polymer film consistent with implementations of the current subject matter, where the film includes 20 percent weight of ketjen black and lithium was deposited on the film at a current density of 3 mA cm⁻² and a capacity of 0.2 mAh cm⁻².

FIG. 20D is an SEM image of a carbon-polymer film consistent with implementations of the current subject matter, where the film includes 20 percent weight of ketjen black and lithium was deposited on the film at a current density of 3 mA cm⁻² and at a capacity of 0.5 mAh cm⁻².

FIG. 20E is an SEM image of the carbon-polymer film of FIG. 20A.

FIG. 20F is an SEM image of the carbon-polymer film of FIG. 20B.

FIG. 20G is an SEM image of the carbon-polymer film of FIG. 20C.

FIG. 20H is an SEM image of the carbon-polymer film of FIG. 20D.

FIG. 21 is a graph showing coulombic efficiency as a function of cycle number in copper foil and films of Example 5, in which all tests involved lithium deposition at a current density of 3 mA cm⁻² and an areal capacity of 3 mAh cm⁻², followed by stripping until the electrode potential reached 1 V.

FIG. 22 is an SEM image of lithium nucleated on a carbon-polymer film consistent with implementations of the current subject matter, where the film includes 5 percent weight of super P and lithium was deposited at a current density of 3 mA cm⁻² and a areal capacity of 3 mAh cm⁻², and the electrolyte was LDME.

FIG. 23A is a graph illustrating the atomic concentration of the film of FIGS. 5C and 5D and of the film of FIGS. 5G and 5H.

FIG. 23B shows F1s spectra of the film of FIGS. 5C and 5D and of the film of FIGS. 5G and 5H.

FIG. 23C shows C1s spectra of the film of FIGS. 5C and 5D and of the film of FIGS. 5G and 5H.

FIG. 24A is a graph illustrating cycling stability of the 1.2 Ah pouch cell with the anode free design of Example 6, where the electrolyte was LDME and the constant current constant voltage (CCCV) cycling was performed at 0.6 C rate, with the voltage window of 3-4.3 V, and the total time of CC and CV was 100 minutes.

FIG. 24B is a partial schematic of the 1.2 Ah pouch cell with the anode free design of Example 6.

FIG. 25A is an optical image of a copper foil.

FIG. 25B is an optical image of a copper foil with holes generated by laser drilling with light spots formed by a flashlight behind the foil, where the gap between the holes is 0.125 inches.

FIG. 25C is an SEM image of an individual laser drilled hole of copper foil of FIG. 25B.

FIG. 25D is an optical image of a film consistent with implementations of the current subject matter that is coated on the copper foil of FIG. 25B.

FIG. 25E is an optical image of the film of FIG. 25D with light spots formed by the flashlight behind the copper foil.

FIG. 25F is an SEM image of a portion of the film of FIG. 25D.

FIG. 26A is an optical image of the NMC811 cathode with holes created by laser drilling, where the gaps between the holes is 0.125 inches.

FIG. 26B is an SEM image of a laser-drilled hole in the NMC811 cathode of FIG. 26A.

FIG. 27 is a schematic of an exemplary lithium metal battery, consistent with implementations of the current subject matter.

FIG. 28 is a schematic of a half-cell that includes a carbon-polymer film, consistent with implementations of the current subject matter.

FIG. 29 is a schematic of a pouch cell that includes a carbon-polymer film, consistent with implementations of the current subject matter.

When practical, similar reference numbers denote similar structures, features, or elements.

### DETAILED DESCRIPTION

In the following description, certain specific details are set forth in order to provide a thorough understanding of various aspects. However, one skilled in the art will understand that the disclosure can be practiced without these details. In other instances, well-known structures have not been shown or described in detail to avoid unnecessarily obscuring descriptions of the aspects. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed disclosure.

Reference throughout this specification to “one aspect” or “an aspect” means a particular feature, structure or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics can be combined in any suitable manner in one or more aspects. Also, as used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The word “about” when immediately preceding a numerical value means a range of plus or minus 10% of that value, e.g., “about 50” means 45 to 55, “about 25,000” means 22,500 to 27,500, etc. Furthermore, the phrases “less than about” a value or “greater than about” a value should be understood in view of the definition of the term “about” provided herein.

It is understood that the examples and aspects described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

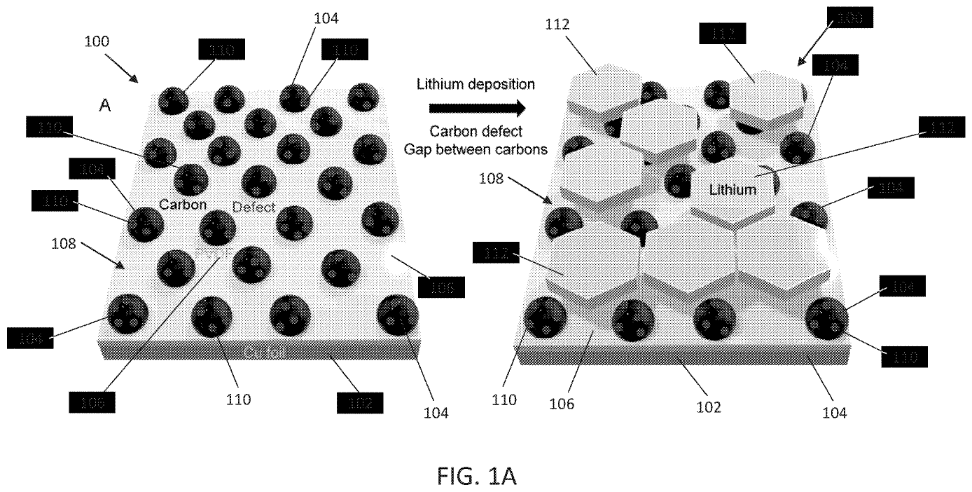

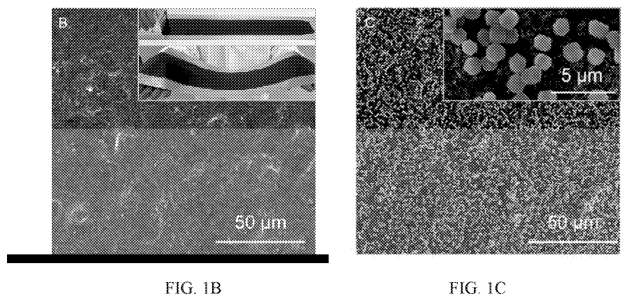

Disclosed herein are carbon-polymer films that include carbon particles and one or more polymers and are configured to regulate the nucleation of lithium and facilitate the formation of faceted lithium seeds on its surface (see, e.g., FIG. 1A). It has been discovered herein that the defects on carbon particle surfaces can serve as nucleation sites. The concentration and distribution of the defects can be designed by adjusting the carbon concentration in the films disclosed herein. In addition to the carbon concentration within the film, different carbon materials and/or chemical or thermal treatments can affect the concentration and distribution of the defects. Implementation of the films disclosed herein can improve the lithium nucleation process, leading to the formation of dense lithium layers for long-life lithium metal batteries.

In general, the present carbon-polymer films disclosed herein include carbon particles and one or more polymers, in which the carbon particles are present in the film in an amount of about 30 weight percent or lower and the carbon particles have a I_{D}/I_{G} ratio of about 1 or greater and at least a portion of the total amount of carbon particles are present at an outer-most surface of the film. This allows for nucleation of faceted lithium seeds on the film. As such, faceted lithium seeds are on a surface of exposed carbon defects of the carbon particles in response to being exposed to Li+ ions during charging of the lithium metal battery. The exposed carbon defects of the carbon particles are those carbon particles present at the outer-most surface of the film.

In some aspects, the film can haves a thickness of about 3 micrometers or less. In certain aspects, the film can have a thickness of about 2 micrometers. In other aspects, the film can have a thickness from about 100 nanometers to about 3 micrometers.

As used herein, “faceted lithium seeds” are lithium seeds with one or more flat fronts and one or more sharp edges. For example, faceted lithium seeds can have a dodecahedron or hexagonal shape. In some aspects, at least one faceted lithium seed of the plurality of faceted seeds can have a hexagonal shape. In certain aspects, the majority of the faceted lithium seeds can have a hexagonal shape. In some aspects, at least one faceted lithium seed of the plurality of faceted seeds can have a dodecahedron shape. In certain aspects, the majority of the faceted lithium seeds can have a dodecahedron shape.

In some aspects, the plurality of faceted lithium seeds can be generally uniform relative to each other, e.g., in size, shape, or both. In one aspect, the plurality of faceted lithium seeds are generally uniform in shape relative to each other. Alternatively, or in addition, the plurality of faceted lithium seeds can be generally uniform in size relative to each other (e.g., ±0.3 microns).

In some aspects, the plurality of faceted lithium seeds can have a median size of about 0.1 microns to about 1,000 microns. In certain aspects, the plurality of faceted lithium seeds can have a median size of about 0.5 microns to about 50 microns. In one aspect, the plurality of faceted lithium seeds can have a median size of about 2 microns.

As discussed above, the present carbon-polymer films disclosed herein include carbon particles that present in the film in an amount of about 30 weight percent or lower and the carbon particles have a I_{D}/I_{G} ratio of about 1 or greater. In some aspects, the carbon particles can be present in the film in an amount from about 1 weight percent to about 30 weight percent. In certain aspects, the carbon particles can be present in the film in an amount from about 5 weight percent to about 20 weight percent. In other aspects, the carbon particles can be present in the film in an amount of about 20 weight percent.

In some aspects, the I_{D}/I_{G} ratio of the carbon particles can be from about 1 to about 2. In other aspects, the I_{D}/I_{G} ratio of the carbon particles can be from about 1 to about 1.5. In certain aspects, the I_{D}/I_{G} ratio of the carbon particles can be from about 1.01 to about 1.29. In yet other aspects, the I_{D}/I_{G} ratio of the carbon particles can be about 1.2 or greater.

The carbon particles can include a variety of carbon material. Non-limiting examples of suitable carbon particles include heteroatom-doped graphite, heteroatom-doped graphene, super P conductive carbon black, ketjen black, single-walled carbon nanotubes, multi-walled carbon nanotubes, carbon nanofibers, heteroatom-doped carbon, or any combination thereof. In one aspect, the carbon particles can include ketjen black.

As noted above, the distribution of the carbon defects can affect the mode of the lithium nucleation on the carbon particles. In other words, gaps between the carbon particles can impact the deposition of the faceted lithium seeds on film. In some aspects, at least two carbon particles present in the film can be spaced apart at a distance from each other. In certain aspects, the distance can be from about 1 nm to about 100 nm, from about 1 nm to about 38 nm, from about 8 nm to about 38 nm, or from about 10 nm to about 40 nm.

In some aspects, the carbon particles can an average particle size from about 1 nm to about 3000 nm. The average particle size of the carbon particles can be based on a certain number of carbon particles, e.g., 1,000 carbon particles. In certain aspects, the carbon particles can have an average particle size from about 1 nm to about 100 nm. In other aspects, the carbon particles have an average particle size from about 30 nm to about 100 nm.

In some aspects, the carbon particles can have an average surface area from about 1 m²g⁻¹ to about 10,000 m²g⁻¹. The average surface area can be calculated using the Brunauer, Emmett, and Teller (BET) theory. In certain aspects, the carbon particles can have a surface area from about 1 m²g⁻¹ to about 2,000 m²g⁻¹. In other aspects, the carbon particles can have a surface area from about 100 m²g⁻¹ to about 2,000 m²g⁻¹.

In some aspects, the one or more polymers can be present in the film in an amount of about 70 weight percent or greater. In certain aspects, the one or more polymers can be present in the film in an amount of about 95 weight percent or greater. Non-limiting examples of suitable polymers include polyvinylidene fluoride, polytetrafluoroethylene, nitrile butadiene rubber, hydrogenated nitrile butadiene rubber, styrene-butadiene rubber, or any combination thereof. In one aspect, the one or more polymers can include polyvinylidene fluoride. In another aspect, the one or more polymers do not include a water-based polymer.

In some aspects, the film can be on a surface of a base substrate that includes one or more conductive materials. Non-limiting examples of suitable conductive materials include copper, stainless steel, silver, gold, zinc, aluminum, tungsten, nickel, iron, titanium, alloys thereof, or any combination thereof. In one aspect, the base substrate is a copper foil.

The combination of the carbon-polymer film and the plurality of facetted lithium seeds can be collectively referred to herein as a negative electrode. In instances where the carbon-polymer film is on a base substrate, the base substrate can be part of the negative electrode. An exemplary carbon-polymer film 100 on a base substrate 102 (e.g., copper foil) is illustrated in FIG. 1A (right side), which includes carbon particles 104 and one or more polymers 106. As shown, at least a portion of the total amount of carbon particles 104 are present at an outer-most surface 108 of the film 100 and the exposed carbon defects 110 on the surface of those carbon particles 104. In use, once the film 100 is exposed to current, faceted lithium seeds 112 nucleate on a surface of the exposed carbon defects 110, as schematically illustrated in FIG. 1A (left side). A person skilled in the art would appreciate that at least the number and size of the faceted lithium seeds depend at least upon the deposition parameters, and therefore the number and size of the facetted seeds should not be limited to what is illustrated in the figures.

The method of manufacturing a negative electrode can include any suitable method. In one aspect, the method can include mixing carbon particles, one or more polymers, and one or more solvents to form a slurry; drying the slurry to remove the one or more solvents to form a carbon-polymer film, in which the carbon particles are present in the film in an amount of about 30 weight percent or lower and the carbon particles have a I_{D}/I_{G} ratio of about 1 or greater; and at least a portion of the total amount of carbon particles are present at an outer-most surface of the film, and exposing the film to electrical current such that a plurality of faceted lithium seeds nucleate on a surface of exposed carbon defects of the carbon particles present at the outer-most surface of the film. In some aspects, the method can include calendaring the film prior to exposing the film to electrical current.

In another aspect, the method can include mixing carbon particles, one or more polymers, and one or more solvents to form a slurry; drying the slurry to remove the one or more solvents to form a carbon-polymer film, in which the carbon particles are present in the film in an amount of about 30 weight percent or lower and the carbon particles have a I_{D}/I_{G} ratio of about 1 or greater; and at least a portion of the total amount of carbon particles are present at an outer-most surface of the film, and depositing lithium onto the outer-most surface of the film. In certain aspects, the depositing lithium can be carried out using chemical vapor deposition. In some aspects, the film can be calendared prior to depositing lithium onto the outer-most surface of the film.

In some aspects, the one or more solvents comprise n-methyl-2-pyrrolidone (NMP), dimethylformamide, acetone, water, tetrahydrofuran, or any combination thereof.

In some aspects, drying the slurry can include vacuum drying the slurry, convection drying the slurry, infrared drying the slurry, microwave drying the slurry, spray drying the slurry, or any combination thereof.

In some aspects, the method can also include prior to drying the slurry, depositing the slurry onto at least one surface of a base substrate. The base substrate can include one or more conductive materials. Non-limiting examples of suitable conductive materials include copper, stainless steel, silver, gold, zinc, aluminum, tungsten, nickel, iron, titanium, alloys thereof, or any combination thereof. In some aspects, depositing the slurry can include casting the slurry onto the surface of the base substrate. Alternatively, or in addition, in some aspects, the method can include ball-milling the carbon particles prior to mixing the carbon particles. Alternatively, or in addition, in some aspects, the method can include annealing the carbon particles prior to mixing the carbon particles.

The present carbon-polymer films disclosed herein can be implemented into a lithium metal battery. In general, the lithium metal batteries disclosed herein include a cathode (e.g., a first cathode), a negative current collector (e.g., a first negative current collector), an anode (e.g., a first anode), one or more separators (e.g., one or more first separators), and one or more electrolytes (e.g., one or more first electrolytes). The negative current collector includes any one of the carbon-polymer films disclosed herein, and the anode includes the plurality of faceted lithium seeds. The one or more separators are positioned between the anode and the cathode, and an amount of the one or more electrolytes is positioned between the cathode and at least one separator of the one or more separators and another amount of the one or more electrolytes is positioned between the anode and the at least one separator of the one or more separators.

In some aspects, the lithium metal battery can have more than one cathode, more than one negative current collector, more than one anode, or any combination thereof.

In one aspect, the lithium metal battery can include another cathode, another negative current collector that includes any one of the carbon-polymer films disclosed herein, another anode, or any combination thereof. The another anode can include a plurality of faceted lithium seeds, in which the plurality of faceted lithium seeds are on a surface of exposed carbon defects of the carbon particles present at the outer-most surface of film of the another negative current collector. The another cathode can be formed of the same or different material relative to the first cathode. The carbon-polymer film of the another negative current collector can be formed of the same or different material that the carbon-polymer film of the first negative current collector. The another anode can be formed of the same or different material relative to the first anode.

In some instances, the lithium metal battery can include a base substrate having the negative current collector positioned on a surface thereof. The base substrate includes one or more conductive materials. Non-limiting examples of suitable conductive materials include copper, stainless steel, silver, gold, zinc, aluminum, tungsten, nickel, iron, titanium, alloys thereof, or any combination thereof. In one aspect, the base substrate is a copper foil. In instances where the lithium metal battery has an anode free design and prior to nucleation of the faceted lithium seeds, the negative current collector and the base substrate in combination can function as an anode. Once the faceted lithium seeds nucleate on the film, the lithium thereof functions as the anode.

The cathode can include a variety of materials. In some aspects, the cathode can include lithium. Non-limiting examples of suitable materials include LiCoO₂, LiMnₓFe_{y}PO₄ wherein x+y=1, LiNiₓMn_{y}CO₂O₂ wherein x+y+z=1, LiNiₓCo_{y}Al₂O₂ wherein x+y+z=1, sulfur, sulfurized polyacrylonitrile, transition metal halide, or any combination thereof. In one aspect, the cathode includes LiNi_{0.8}Mn_{0.1}Co_{0.1}O₂.

In some aspects, one or more electrolytes can include lithium bis(fluorosulfonyl)imide (LiFSI) in 1,2-dimethoxyethane/bis(2,2,2-trifluoroethyl) ether (DME/BTFE), a carbonate electrolyte, an ether-based electrolyte, or any combination thereof. Non-limiting examples of suitable carbonate electrolytes include lithium hexafluorophosphate (LiPF₆), ethylene carbonate, ethyl methyl carbonate, or any combination thereof.

In some aspects, the one or more separators can include polyethylene, polypropylene, a solid electrolyte, or any combination thereof.

In some aspects, the lithium metal battery can include a positive current collector, in which the cathode can be positioned on or proximate to a surface of the positive current collector. Non-limiting examples of suitable materials for positive current collector include aluminum, copper, gold, silver, or any combinations thereof. In some aspects, the aluminum is a carbon-coated aluminum. In some aspects, the copper is a carbon-coated copper.

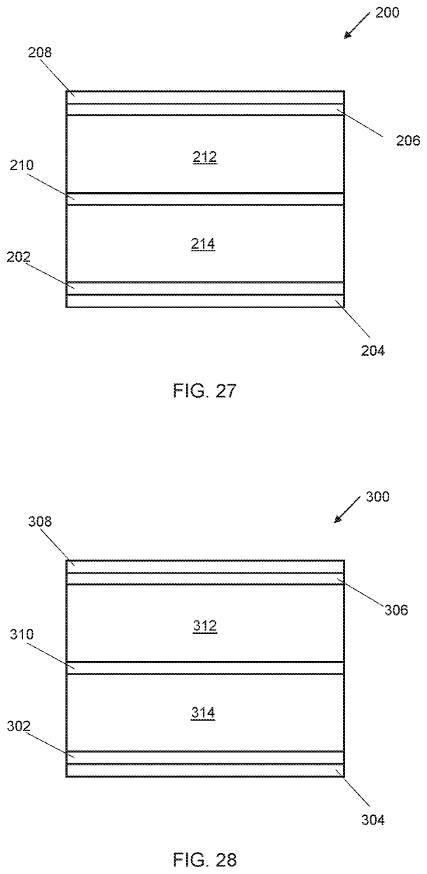

FIG. 27 is a schematic drawing of an exemplary lithium metal battery 200. The lithium metal battery 200 includes a negative current collector 202 disposed on a base substrate 204 (e.g., copper foil), a cathode 206 disposed on a positive current collector 208 (e.g., aluminum foil), and a separator 210 disposed between the cathode 206 and the negative current collector 202. Further, a first electrolyte 212 is disposed between the cathode 206D and the separator 210 and a second electrolyte 214 is disposed between the negative current collector 202 and the separator 214. In some aspects, the first and second electrolytes can be the same electrolyte, while in other aspects, the first and second electrolytes can be different. The negative current collector 202 includes a carbon-polymer film disclosed herein. In FIG. 27, current has not yet been drawn through the lithium metal battery 200, and therefore, the negative current collector 202, i.e., the carbon-polymer film, and the base substrate 204, in combination function as the anode. While not shown, once current is drawn through the lithium metal battery 200, a plurality of faceted lithium seeds will nucleate on the outer-most surface of the carbon-polymer film, namely on a surface of exposed carbon defects of the carbon particles present at the outer-most surface of the film.

The present lithium metal batteries disclosed herein can be formed using any suitable method. In one aspect, the method can include providing a negative current collector, providing a cathode on a positive current collector, applying one or more electrolytes to a separator, positioning a first surface of a separator adjacent to the cathode, in which an amount of the one or more electrolytes is positioned between the separator and the cathode, positioning the negative current collector adjacent a second, opposing surface of the separator, where another amount of the one or more electrolytes is positioned between the separator and the negative current collector, and exposing the negative current collector to electrical current such that a plurality of faceted lithium seeds nucleate on a surface of exposed carbon defects of the carbon particles present at the outer-most surface of the film. The negative current collector includes a carbon-polymer film that includes carbon particles and one or more polymers, in which the carbon particles are present in the film in an amount of about 5 weight percent or greater and the carbon particles have a I_{D}/I_{G} ratio of about 1 or greater; and at least a portion of the total amount of carbon particles are present at an outer-most surface of the film.

In some aspects, providing the negative current collector can include mixing the carbon particles, the one or more polymers, and one or more solvents to form a slurry, drying the slurry to form the film. In such aspects, the method can include applying the film to a surface of a base substrate, the base substrate including one or more conductive materials. In certain aspects, providing the negative current collector can also include calendaring the film.

In some aspects, providing the negative current collector can include mixing the carbon particles, the one or more polymers, and one or more solvents to form a slurry, depositing the slurry onto at least one surface of a base substrate, where the base substrate includes one or more conductive materials, and drying the slurry on the base substrate to remove the one or more solvents to form the film. In some aspects, depositing the slurry can include casting the slurry onto the surface of the base substrate. In certain aspects, providing the negative current collector can also include calendaring the film.

In some aspects, the base substrate can include one or more conductive materials. Non-limiting examples of suitable conductive materials copper, stainless steel, silver, gold, zinc, aluminum, tungsten, nickel, iron, titanium, alloys thereof, or any combination thereof.

In some aspects, the one or more solvents can include n-methyl-2-pyrrolidone, dimethylformamide, acetone, water, tetrahydrofuran, or any combination thereof.

In some aspects, drying the slurry can include vacuum drying the slurry, convection drying the slurry, infrared drying the slurry, microwave drying the slurry, spray drying the slurry, or any combination thereof. Alternatively, or in addition, the method can include ball-milling the carbon particles prior to mixing the carbon particles. Alternatively, or in addition, the method can include annealing the carbon particles prior to mixing the carbon particles.

FIG. 28 is a schematic drawing of an exemplary half cell 300. The half cell 300 includes a negative current collector 302 disposed on a base substrate 304 (e.g., copper foil), a cathode 306 (e.g., lithium foil) disposed on a positive current collector 308 (e.g., copper foil), and a separator 310 disposed between the cathode 306 and the negative current collector 302. Further, a first electrolyte 312 is disposed between the cathode 306 and the separator 310 and a second electrolyte 314 is disposed between the negative current collector 302 and the separator 314. In some aspects, the first and second electrolytes can be the same electrolyte, while in other aspects, the first and second electrolytes can be different. The negative current collector 302 includes a carbon-polymer film disclosed herein. In FIG. 28, current has not yet been drawn through the half cell 300, and therefore, the negative current collector 302, i.e., the carbon-polymer film, and the base substrate 304, in combination function as the anode. While not shown, once current is drawn through the half cell, a plurality of faceted lithium seeds will nucleate on the outer-most surface of the carbon-polymer film, namely on a surface of exposed carbon defects of the carbon particles present at the outer-most surface of the film.

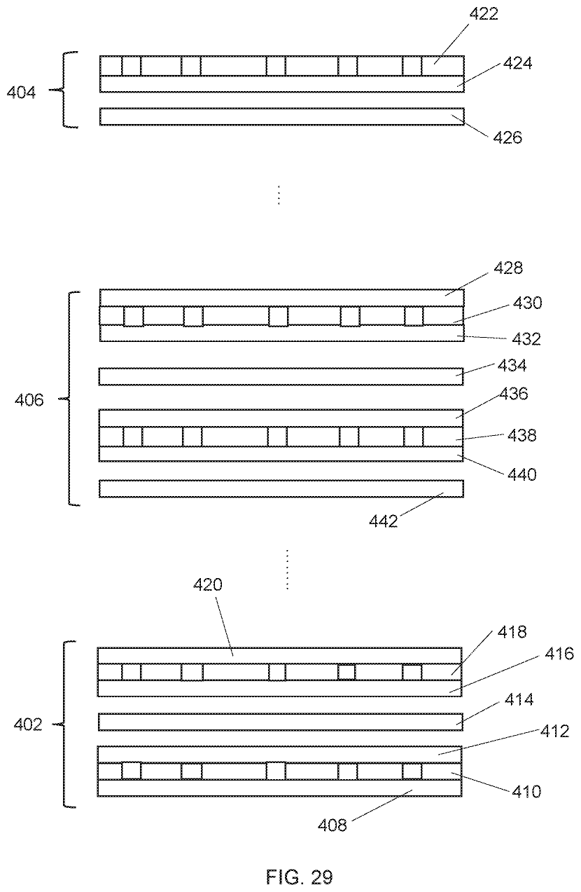

FIG. 29 is a partial exploded schematic of an exemplary pouch cell 400. The pouch cell includes a first stack 402, a second stack 404, and a third stack 406 interposed therebetween. The third stack 406 can be a repeat unit of the pouch cell 400. While not shown, the pouch cell 400 includes one or more electrolytes.

In this illustration, the first stack 402 includes, starting at the bottom of the pouch cell 400, a first substrate 408 (e.g., lithium foil), a first base substrate 410 (e.g., a porous copper foil), a first negative current collector 412, a first separator 414, a first cathode 416, a first positive current collector 418 (e.g., porous aluminum film) and a second cathode 420. The first negative current collector 412 includes a first carbon-polymer film disclosed herein. The first carbon-polymer film can include any carbon-polymer film disclosed herein.

As further shown, the second stack 404, starting at the top of the pouch cell 400, a second base substrate 422 (e.g., porous copper foil), a second negative current collector 424, and a second separator 426. The second negative current collector 424 includes a second carbon-polymer film. The second carbon-polymer film can include any carbon-polymer film disclosed herein. The third stack 406 includes a third cathode 428, a second positive current collector 430, a fourth cathode 432, a third separator 434, a third negative current collector 436, a third base substrate 438, a fourth negative current collector 440, and a fourth separator 442. The third and fourth negative current collectors 436, 440 include a third carbon-polymer film and a fourth carbon-polymer film, respectively. The third and fourth carbon-polymer films can each include any carbon-polymer film disclosed herein.

The following specific examples are intended to be illustrative of the subject matter and should not be construed as limiting the scope of the subject matter as defined by appended claims.

### EXAMPLES

### Materials

Lithium foil (100 μm), graphene, ketjen black (KB, EC600JD), carbon nanotubes (MSE PRO Multi-walled Carbon Nanotubes), and polyvinylidene fluoride (PVDF) binder were ordered from MSE Supplies. Super P carbon was received from TIMCAL. Graphite was received from Xiamen Knano Graphene Technology Co. Graphene (graphene nanoplatelets) was ordered from Sigma. LiNi_{0.8}Mn_{0.1}Co_{0.1}O₂ (NMC811) powders were purchased from Targray Technology International Inc. The NMC811 electrode (5 mAh cm⁻²) was obtained from the University of Maryland, which in turn acquired it from Saft. Lithium bis(fluorosulfonyl)imide (LiFSI) and 1,2-dimethoxyethane (DME) were purchased from Gotion. Bis(2,2,2-trifluoroethyl) ether (BTFE) was purchased from TCI. Electrolytes were prepared by dissolving predetermined amounts of LiFSI salt into the solvents of interest and stirred.

### Carbon-Polymer Film Preparation

The film was fabricated by a slurry casting method. Initially, carbon and polyvinylidene fluoride (PVDF) were ground together in specified weight ratios using a mortar and pestle. The resulting mixture was then dispersed in N-methyl pyrrolidone (NMP, Sigma-Aldrich) using a Thinky Mixer, operating at 2000 rpm for 1 hour. Subsequently, the obtained slurry was cast onto a copper foil (9 μm, MTI) using a film casting doctor blade and an automatic film coater (MSK-AFA-III). Lastly, the film was subjected to vacuum drying at 110 °C for a duration of 12 hours. In the below examples, the carbon-polymer films are referred to as C-W, where C denotes the carbon type (C: G, Gr, SP, KB, and CNT), and W represents the weight ratio of carbon in the film. For example, a K-20 film includes 20 weight percent of ketjen black and 80 weight percent of PVDF.

### Carbon Milling

Carbon powders and zirconia milling balls, in a weight ratio of 1:20, were placed into a 150 mL Thinky container. The container was securely sealed and loaded into a Thinky mixer, set to operate at 2000 RPM. The carbon particles were subjected to ball milling for one hour. After completion, the ball-milled carbon particles were collected for subsequent use or analysis.

### Carbon Annealing

Carbon powders were placed in a high purity graphite crucible (SPEX, USA) and subsequently annealed in a RD Webb “Red Devil” furnace (MA, USA) at 2000 °C for 2 h under flowing argon. The furnace was pumped down to a rough vacuum (10⁻²-10⁻³ mbar) overnight to evacuate as much oxygen from the hot zone and carbon powder sample as possible prior to the annealing step. A heating rate of 25 °C min⁻¹ was employed till 1500 °C. After a 30-minute soak to stabilize the temperature in the hot zone, the temperature was increased to 2000 °C at a rate of 10 °C min⁻¹ and held for 2 h. The sample was subsequently furnace cooled at the end of the annealing cycle.

### Cathode Preparation

The NMC811 electrode (for coin-cell tests) was prepared by coating a slurry composed of NMC811 powder, Super P, PVDF binder in a ratio of 90:5:5 wt % with NMP as the solvent on a carbon coated aluminum foil. The coated electrode was vacuum dried at 110 °C. The cathode active material loading is around 22 mg cm⁻².

### Electrochemical Test

2032-type coin cells were used for the electrochemical studies herein. The Li foil (100 μm) was punched to 12 mm discs as the counter electrode. Celgard 2325 was used as the separator. The caron-polymer films were punched to 14 mm discs as the working electrodes. A fixed amount of electrolyte (50 μL) was added in each cell. Lithium deposition and galvanostatic cycling was conducted on a Land battery tester.

For NMC811 coin cell tests, a carbon-polymer film (20 weight percent of ketjen black, the weight ratio of KB:PVDF was 1:4) with 4 mAh cm⁻² Li and coated onto a copper foil was punched into 15 mm discs. Commercial Li foil (20 μm) was also punched to 15 mm discs. The discs of the film with 4 mAh cm⁻² Li were used as the anode in their NMC811 coin cell tests and the discs of the commercial Li foil with were used as the anode in their NMC811 coin cell test. In all the NMC811 coin cell tests, the NMC811 electrode was punched to 14 mm discs and used as the cathode, and Celgard 2325 was used as the separator. The NMC811 coin cells were constructed with an electrolyte/capacity ratio of 3 g Ah⁻¹. The cells were cycled at a C/10 rate for 3 cycles and then tested under predetermined rates (1C=200 mA g⁻¹). Galvanostatic charge/discharge cycling was conducted between 3 and 4.4 V on a Land battery tester.

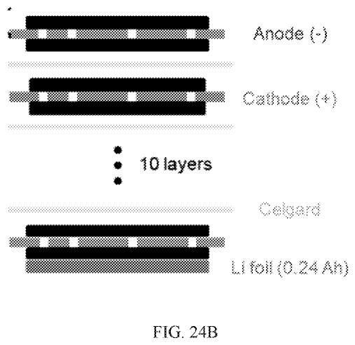

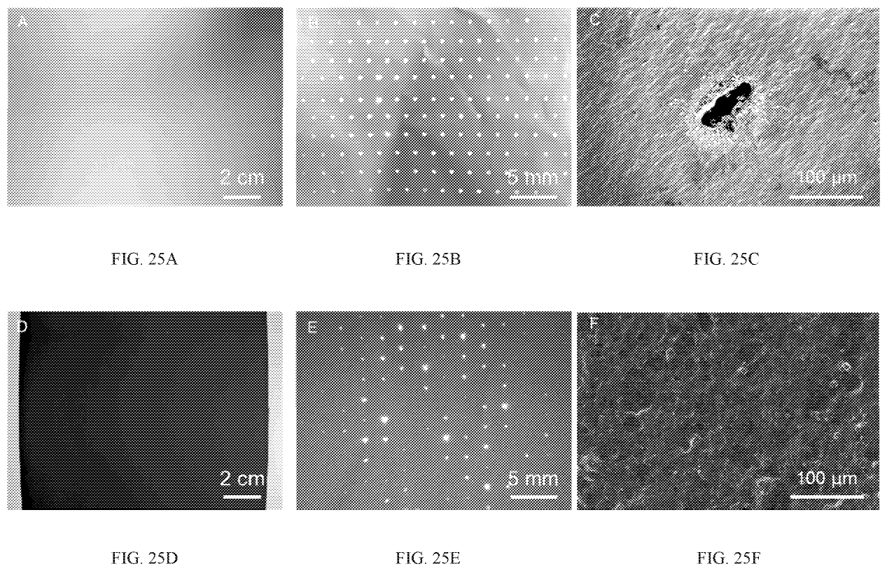

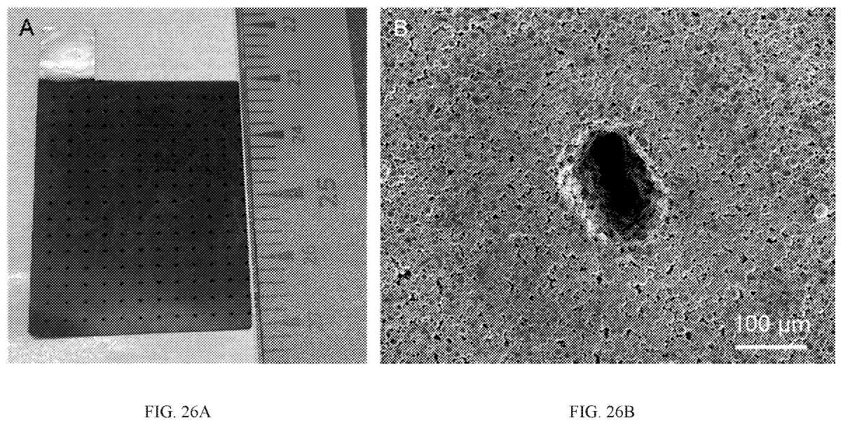

For NMC811 pouch cell tests, a double coated film (i.e., a first film positioned on a first surface of a copper foil and a second film positioned on a second, opposing surface of the copper foil) that contained 20 weight percent of ketjen black was punched to 3.1 cm*4.1 cm and used as the anode. The double-side coated NMC811 electrode (the areal capacity of each side: 5 mAh cm⁻²) was punched to 3 cm*4 cm and used as the cathode, Li foil (100 μm) was pouched to 3.1 cm*4.1 cm. As shown in FIGS. 24A and 24B, each pouch cell contained 11 layers of anodes, 10 layers of cathodes, one layer of lithium, wherein the lithium layer was electrically connected (e.g., allowing electron transfer) to the second film of the anode that was at the bottom of the stack, Celgard 2325 was used as the separator, and LDME was use as the electrolyte. All anodes and cathodes were punched with an array of holes using a laser cutter (FIGS. 25A-26B). The designed capacity of the pouch cell was 1.2 Ah. The. NMC811 pouch cells were constructed with an electrolyte/capacity ratio of 3 g Ah⁻¹. More details regarding the pouch components could be found in Table 1. The cells were cycled at a C/10 rate for 3 cycles and then tested under predetermined rates (1C=200 mA g⁻¹). Galvanostatic charge/discharge cycling was conducted between 3 and 4.3 V on an Arbin battery tester. The total time of CC and CV was 100 minutes.

TABLE 1
Pouch cell information.

| | |
|---|---|
| Number of cathode layers | 10 (double sides) |
| Number of anode layers | 11 (9 double sides + 2 single sides) |
| Number of compensation | 1 (100 μm on Li foil) |
| electrode (Li) | |
| Cathode areal loading | 5 mAh/cm² |
| (single side) | |
| Cathode area | 12 cm² |
| Cathode weight | 6.75 g |
| (including Al) | |
| Anode area | 12.71 cm² |
| Anode weight | 1.42 g |
| (including Cu) | |
| Electrolyte weight | 3.6 g |
| Cell stack weight | 11.77 g |
| Battery weight | 14.01 g |

### XPS Testing

The XPS results were obtained on an AXIS Supra XPS by Kratos Analytical. XPS spectra were collected using a monochromatized Al Kα source (1486.7 eV). Samples were characterized under 10⁻⁸ Torr of vacuum. The cycled electrode was recovered by disassembling the coin cell. All the samples were washed with DME three times and dried in the glovebox antechamber under vacuum. All samples were transferred from a nitrogen filled glovebox which was directly connected to XPS. A 10 keV Ar (1000 atom) cluster source was applied for a 60 s etching. All XPS spectra were calibrated with adventitious C Is (284.8 eV) and analyzed by using the CasaXPS software.

### Scanning Electron Microscopy (SEM)

The SEM images of lithium were obtained on a scanning electron microscopy (FEI Apreo). The cycled electrode was recovered by disassembling the coin cell. All the samples were washed with DME three times and dried in the glovebox antechamber under vacuum. The sample was adhered to a double-sided carbon tape and placed on a specimen holder. The prepared sample was sealed in a glass bottle inside the glovebox for transferring to the SEM. The approximate time of sample exposed to air (from a sealed environment to the SEM stage) was less than 3 s.

### Example 1: Electrodeposited Faceted Lithium Crystals on Carbon-Polymer Films

A carbon-polymer film was fabricated by a slurry casting method. FIG. 1B illustrates the film in which the insert shows an optical image of a large sheet of film coated on copper. Ketjen black (KB) was mixed with polyvinylidene fluoride (PVDF) in N-Methyl-2-pyrrolidone (NMP), followed by casting and vacuum drying to form the carbon-polymer film. The carbon-polymer film (K-20 film) coated Cu foil was used as an electrode in a half cell (e.g., a half cell 300 of FIG. 28). The cell included an electrolyte that was a localized high-concentration electrolyte, specifically 2 M lithium bis(fluorosulfonyl)imide (LiFSI) in 1,2-dimethoxyethane/bis(2,2,2-trifluoroethyl) ether (DME/BTFE) with a weight ratio of 1:4, also known as LDME. This electrolyte ensured a high coulombic efficiency for Li plating and stripping (>99%). As a demonstration, an experiment was conducted in which 0.1 mAh cm⁻² of Li was deposited on films at a current density of 3 mA cm⁻² (see FIG. 1B). Prior to deposition, the cell was discharged to 0 V at a current density of 0.5 mA cm⁻². FIG. 1C shows that hexagonally faceted Li seeds with similar sizes were generally uniformly distributed on the film.

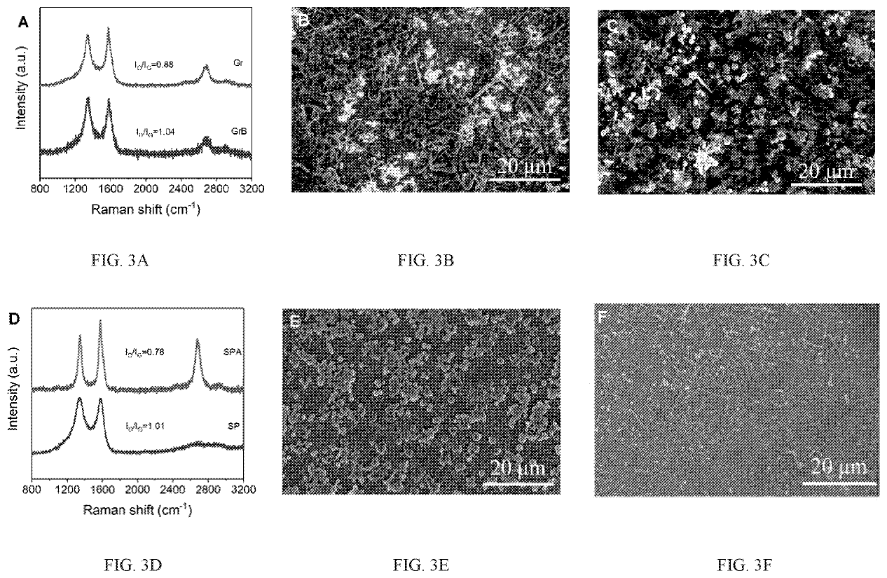

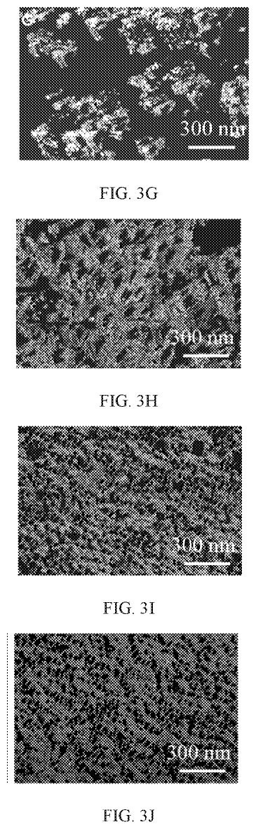

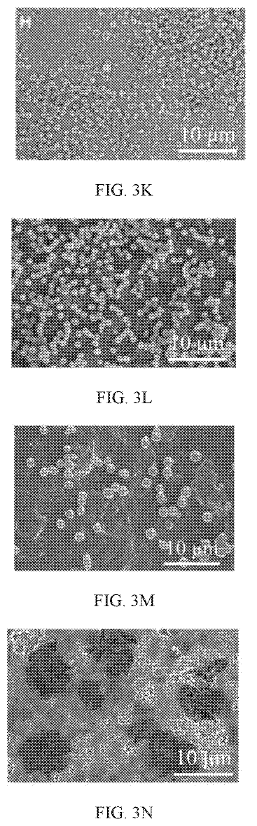

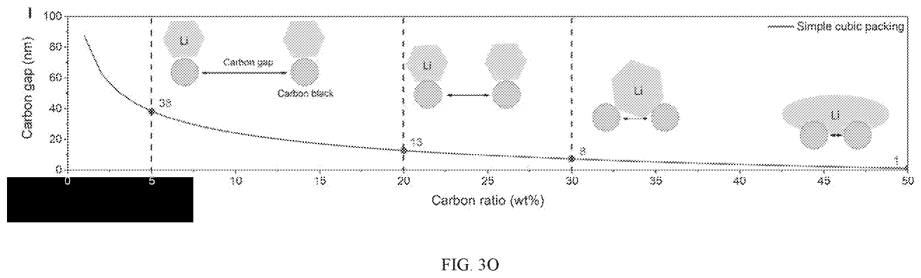

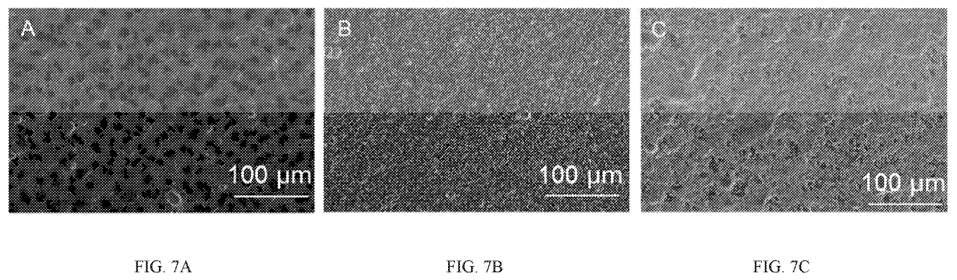

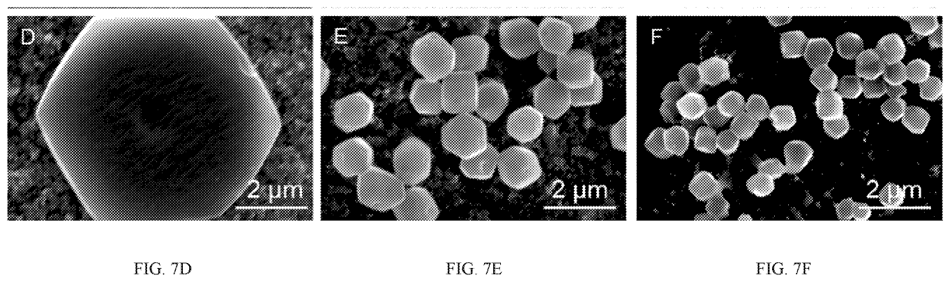

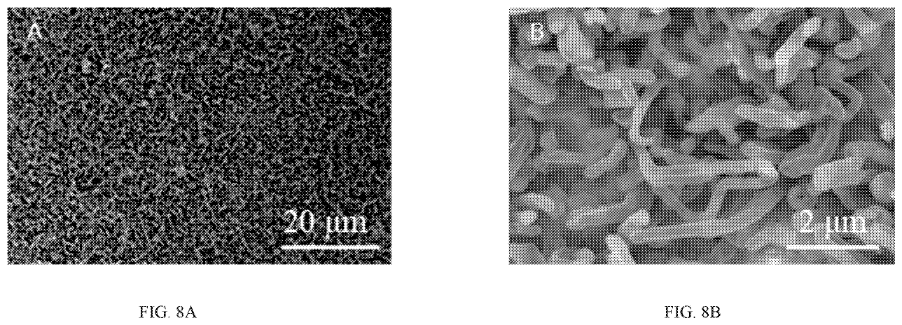

Further, adjusting the current density was found to have an impact on the size of the seeds, with lower current densities resulting in larger crystals and higher current densities leading to smaller ones, as shown in FIGS. 7A-7F. Each figure illustrates an SEM image of Li crystals on a film that includes 20 weight percent of ketjen black where the lithium was deposited at different current densities, namely 0.5 mA cm⁻² (FIGS. 7A and 7D), 3 mA cm⁻² (FIGS. 7B and 7E), or 10 mA cm⁻² (FIGS. 7C and 7F). Under the same condition on bare copper in the same electrolyte, dendrites are formed (see FIGS. 8A and 8B).

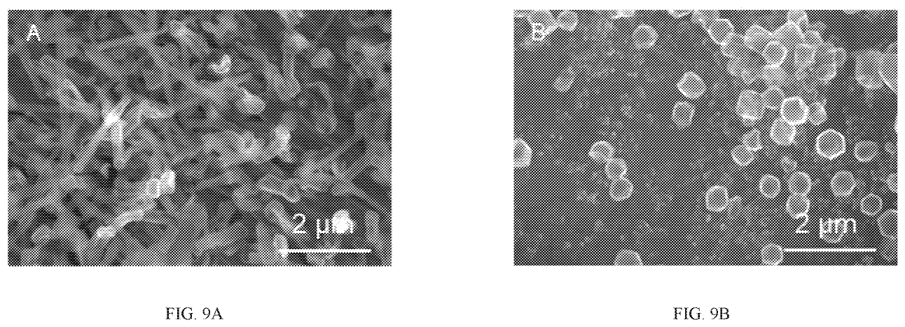

An additional experiment was conducted using a commercial carbonate electrolyte, 1.2 M lithium hexafluorophosphate (LiPF₆) in ethylene carbonate/ethyl methyl carbonate (EC/EMC in 3:7 wt %), where Li deposited on copper foil (FIG. 9A) and on a K-20 film (FIG. 9B) at a constant current of 3 mA cm⁻² and a capacity of 0.1 mAh cm⁻². As shown in FIG. 9B, Li deposited on the K-20 film also exhibited a hexagonal shape, thereby suggesting that this particular shape was primarily influenced by the presence of the carbon-polymer film rather than specific properties of the electrolytes. These hexagonally faceted crystals are likely single crystalline. Without being bound by a single theory, it is believed that the hexagonal shape is the Wulff shape of Li due to the fact that the (110) plane has the lowest surface energy and the lowest surface diffusion barrier under battery working conditions.

### Example 2: Effects of Carbon on Lithium Nucleation

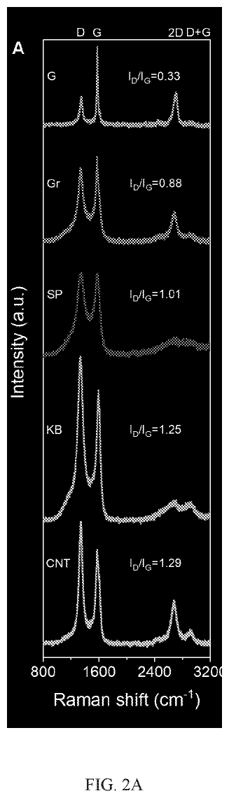

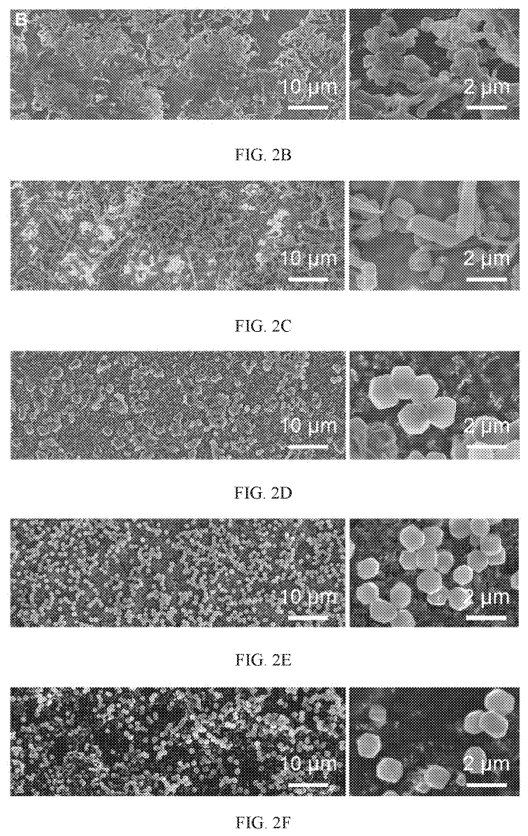

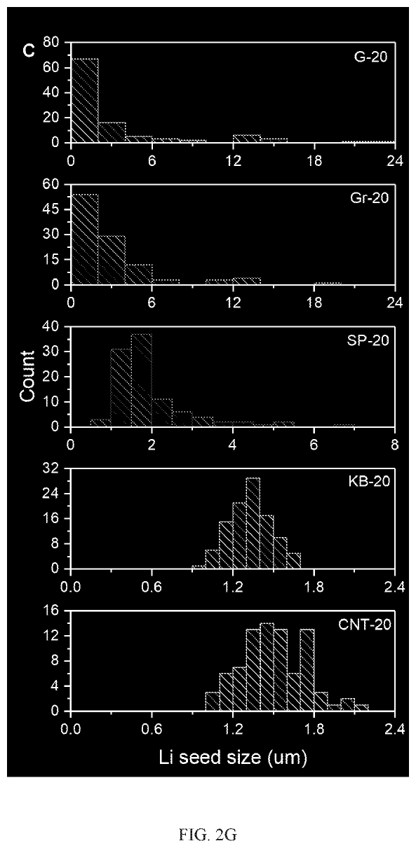

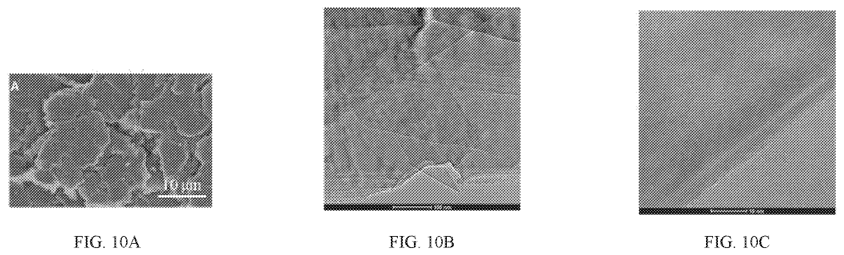

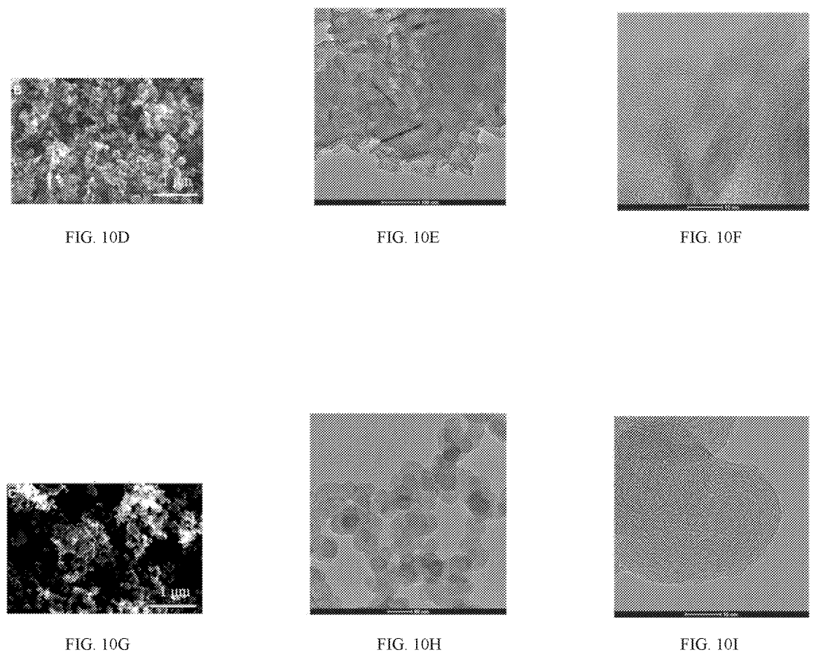

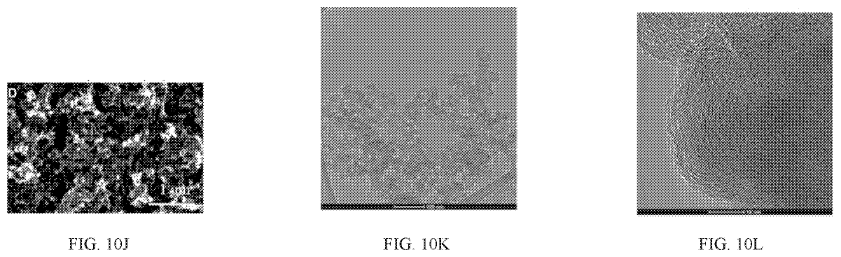

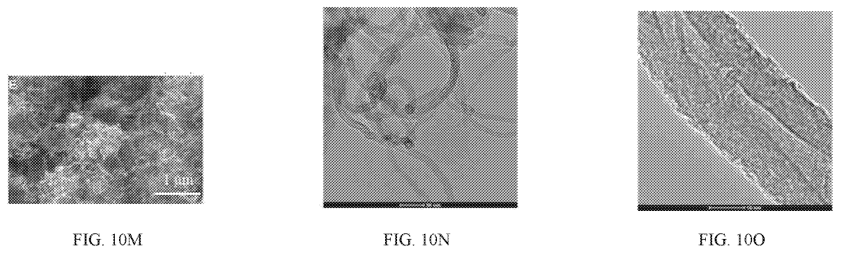

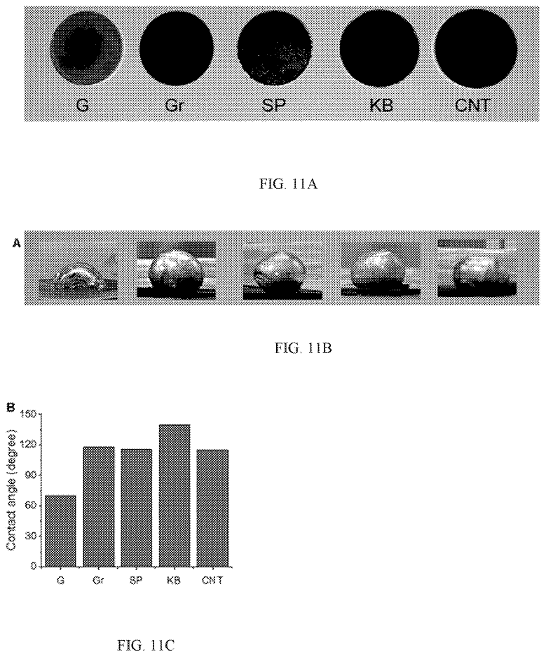

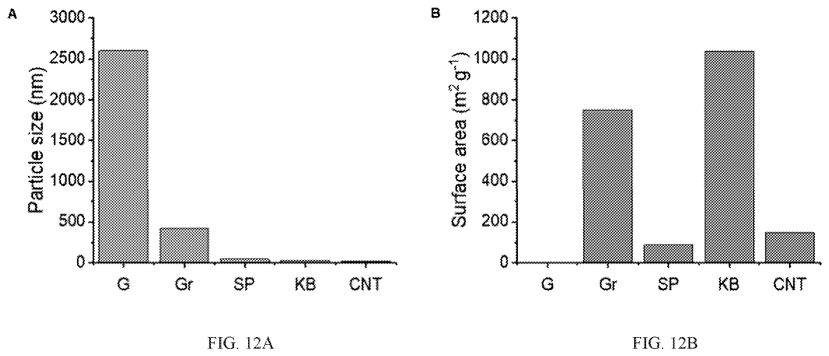

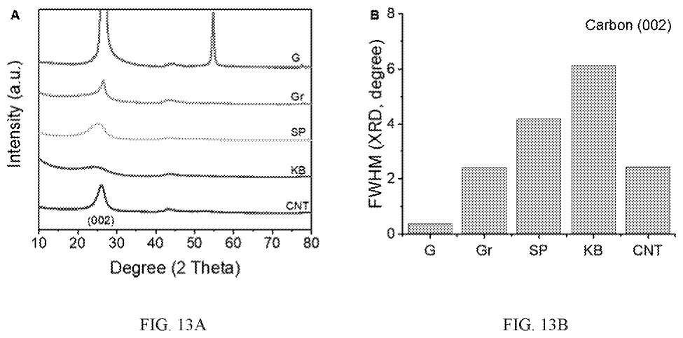

To assess the impact of carbon on Li nucleation, five different types of carbon particles were investigated, namely graphite (G), graphene (Gr), super P (SP), ketjen black (KB), and carbon nanotube (CNT), each possessing a distinct I_{D}/I_{G} ratio (0.33, 0.88, 1.01, 1.25, and 1.29, respectively), as depicted in the Raman spectra shown in FIG. 2A. A higher I_{D}/I_{G} ratio indicates a higher concentration of carbon defects. Carbon defects at least encompass edge and topological defects, which are accompanied by an abundance of unpaired π electrons. These defects play a role in facilitating efficient electron transfer processes and can serve as active sites for various reactions. Additional characterizations of the five different types of carbon particles are shown in FIGS. 10A-13B, namely morphology (see FIGS. 10A-10O), wetting of molten Li on carbon (see FIGS. 11A-11C), particle size and surface area (see FIGS. 12A and 12B), and XRD profiles (see FIGS. 13A and 13B). FIG. 13B illustrates the data analysis of the XRD profiles, in which the FWHM indicates the carbon ordering of the five different types of carbon particles.

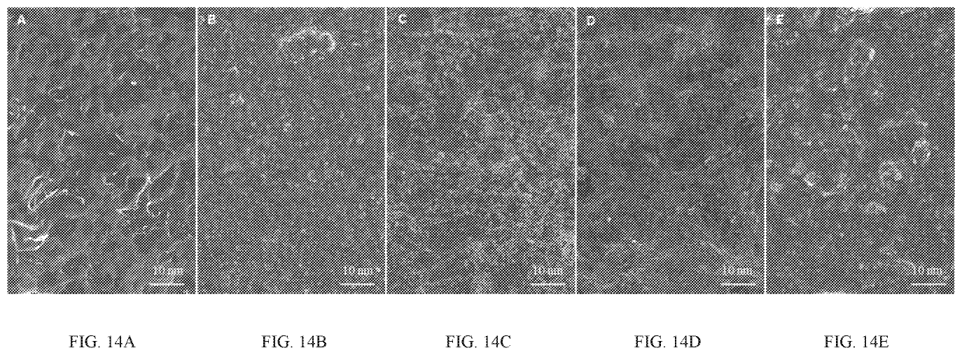

As noted above, the carbon-polymer films are referred to as C-W, where C denotes the carbon type (C: G, Gr, SP, KB, and CNT), and W represents the weight ratio of carbon in the film. In order to facilitate the assessment of the effect of carbon structure, all films shown in FIG. 2B contain a fixed carbon ratio of 20 weight percent. FIG. 14A-14E provides top-view scanning electron microscopy (SEM) images of the films, demonstrating the generally uniform distribution of carbon particles. Carbon typically exhibits an electronic resistivity of around 10⁻³ Ωm. The thickness of carbon-polymer films was approximately 3 μm, resulting in an area-specific resistance (ASR) on the order of 10⁻⁵ Ωcm² for a composite containing 5-20% of carbon, which is negligible as compared to the electrode ASR of typical lithium-ion batteries (10 Ωcm²). As such, it is believed that there would be minimal impact from the carbon-polymer film on the internal resistance within the battery.

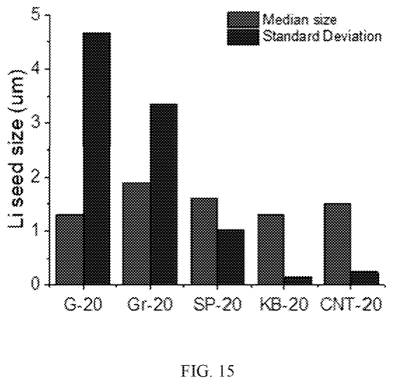

To explore the influence of carbon on the nucleation and initial growth of Li, an experiment was conducted in which 0.1 mAh cm⁻² of Li was deposited on carbon-polymer films at a current density of 3 mA cm⁻². In this experiment, the carbon-polymer films included a G-20 film, a Gr-20 film, a SP-20 film, a KB-20 film, and a CNT-20 film. The SEM images of the electrodeposited Li on these films are presented in FIGS. 2B-2F. Surprisingly, the morphology of the electrodeposited Li varied significantly across the films. On G-20 and Gr-20 films, Li showed a mixture of dendritic and hexagonal shapes with different sizes. However, on SP-20, KB-20, and CNT-20 films, Li shapes consist of relatively uniform hexagons. To quantitatively assess the morphological differences, the sizes of approximately 100 Li particles were measured and the distribution was plotted as shown in FIG. 2G. The median sizes of Li particles across all five films were similar, approximately 2 μm as graphically illustrated in FIG. 15. However, they displayed a significant disparity in terms of standard deviation (SD). The SD values for G-20, Gr-20, SP-20, KB-20, and CNT-20 were 4.68 μm, 3.34 μm, 1.02 μm, 0.15 μm, and 0.24 μm, respectively, as graphically illustrated in FIG. 15. Films with higher I_{D}/I_{G} ratios show greater uniformity (lower SD) in Li size. Interestingly, as shown in FIGS. S5A-S5C, Li nucleated as faceted crystals on KB (with a molten Li contact angle of) 140°, while dendrites formed on graphite (with a molten Li contact angle of) 70°. Increasing the surface area of the film was generally believed to benefit lithium plating by reducing local current density. However, as shown in FIGS. 12A-12B and FIG. 15, the SD of Li seed size on Gr (with a surface area of 750 m² g⁻¹) was three times larger than the SD of Li seed size on SP (with a surface area of 88 m² g⁻¹). The surface area measurements were performed three times using BET. Surprisingly, similar and generally uniform faceted Li seeds occurred on both KB (amorphous carbon) and CNT (graphitic carbon, see FIG. 15).

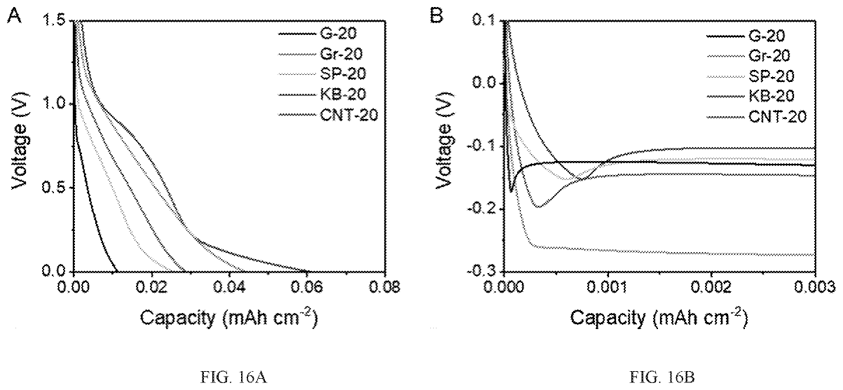

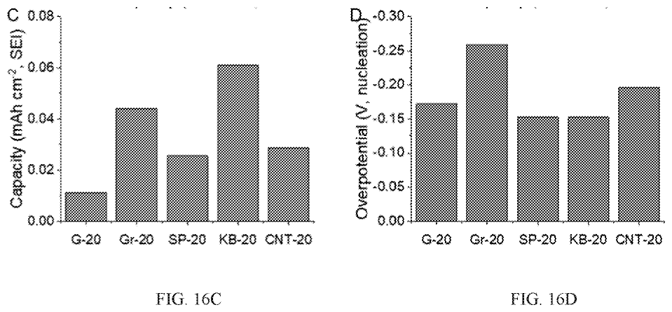

FIG. 16A shows the capacity-voltage curves of carbon films, and FIG. 16C is a summary of the discharge capacity of the carbon films of FIG. 16A. There were five different carbon-polymer films tested, a G-20 film, a Gr-20 film, a SP-20 film, a KB-20 film, and a CNT-20 film. The capacity of the carbon films was evaluated via discharging the half cells with carbon films to 0 V at a current density of 0.5 mA cm⁻². FIG. 16B shows the capacity-voltage curves of lithium plating on the carbon films, and FIG. 16D is a summary of the overpotential of lithium nucleation on the carbon films of FIG. 16B. The overpotential of lithium nucleation on the carbon films was evaluated via firstly discharging the half cells to 0 V at a current density of 0.5 mA cm⁻² and then discharging at a current density of 3 mA cm⁻². The capacity in FIG. 16B is the capacity below 0 V. The lithiation capacities of carbon and the nucleation overpotentials of Li on the films of the Li|carbon-polymer film cells demonstrated low correlation with the SD of Li seed size.

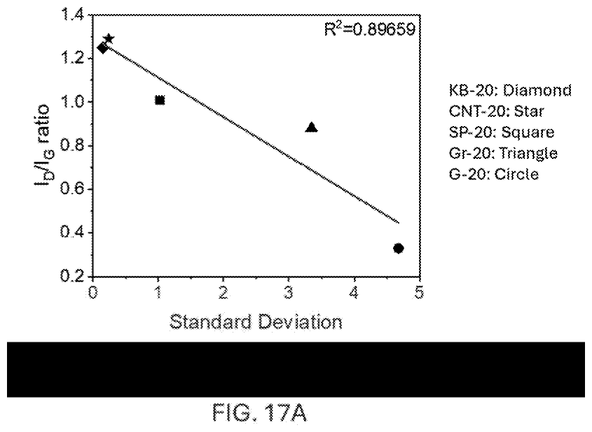

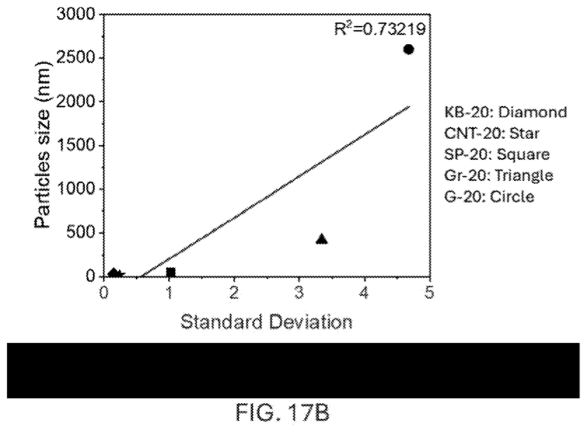

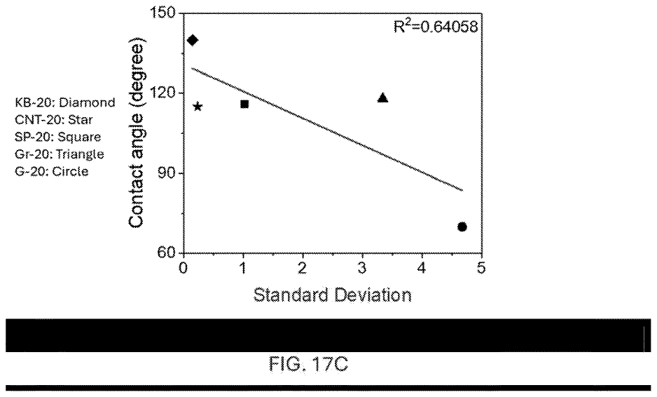

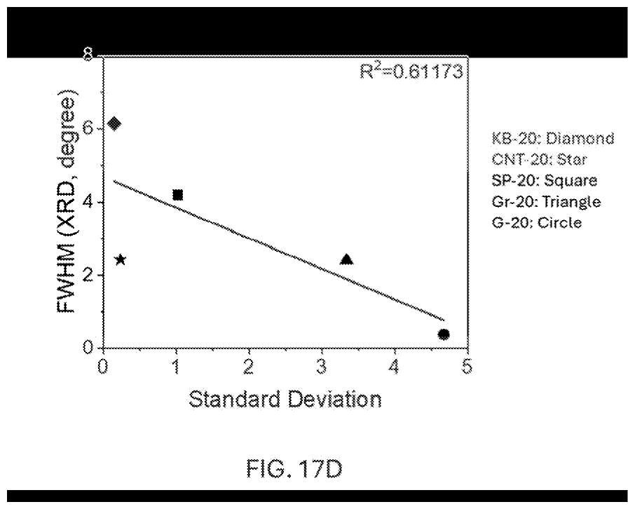

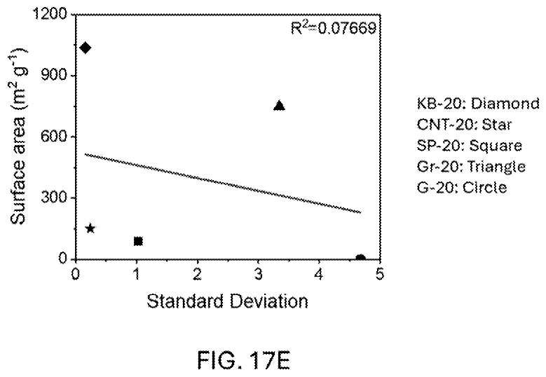

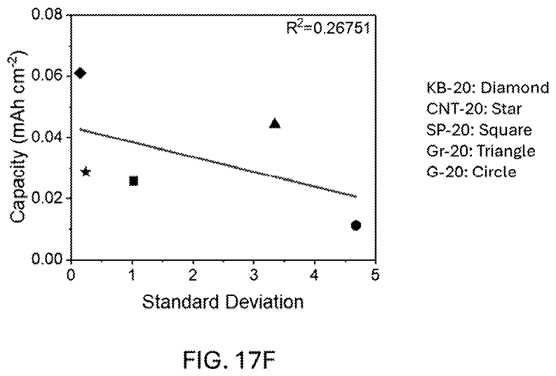

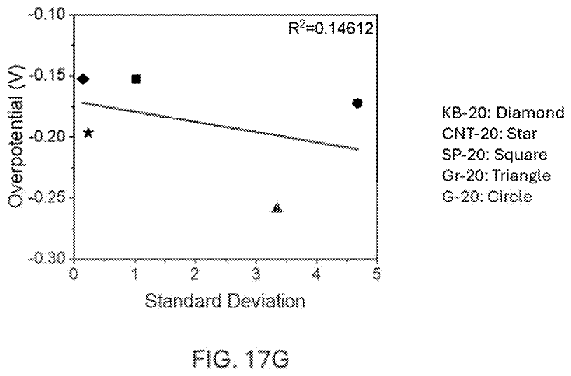

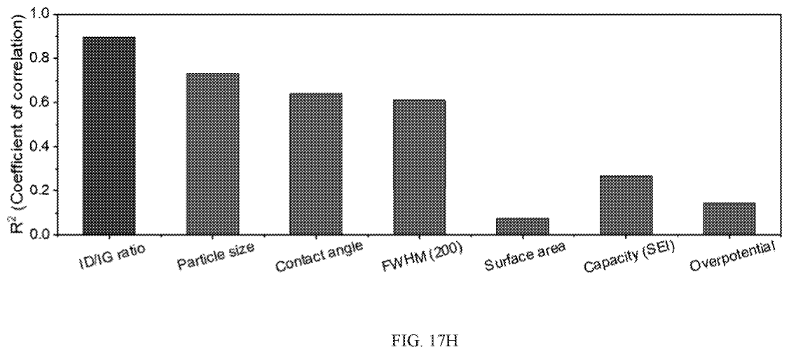

Among all the variables investigated, it was found that the I_{D}/I_{G} ratio exhibited the highest coefficient of correlation with the uniformity of Li seed size (see FIG. 17A-17H), thereby suggesting that the defect density of carbon, rather than its ability to intercalate or wet lithium, drives the nucleation behavior. As such, it was found that carbon defects play a role in Li nucleation and initial Li deposition.

### Example 3: Tuning Defect Density and Distribution to Control Li Nucleation

To gain deeper insights into the effect of carbon defects on Li nucleation and initial deposition, three additional experiments were conducted to manipulate the density and distribution of defects.

The first experiment involved ball milling, where Graphene particles were subjected to one hour of ball milling, resulting in an increase in the I_{D}/I_{G} ratio from 0.88 to 1.04 (Graphene particles after ball milling (GrB), see FIG. 3A). As expected, the uniformity of Li seed deposition on a carbon-polymer film with 20 weight percent of GrB significantly improved, with the standard deviation (SD) decreasing from 3.34 to 0.95, along with a notable reduction in dendrite-like Li structures (see FIG. 3B and FIG. 3C). The SD for the lithium seeds in FIG. 3B and in FIG. 3C were calculated by measuring 100 Li seeds.

The second experiment involved high-temperature annealing, where SP particles were annealed at 2000 °C for 2 hours under flowing argon, which lead to a decrease in the I_{D}/I_{G} ratio from 1.01 to 0.78 (SP particles after annealing (SPA), FIG. 3D). Interestingly, the uniformity of Li seed deposition on a carbon-polymer film with 20 weight percent of SPA deteriorated, as evidenced by an increase in the SD from 1.02 to 2.62, which was calculated by measuring 100 lithium seeds in FIG. 3E and FIG. 3F, respectively. Further, as shown in FIGS. 3E and 3F, there was also the appearance of dendrite-like Li structures. The SD for the lithium seeds in FIG. 3E and in FIG. 3F were calculated by measuring 100 Li seeds.

These results of the first and second experiment collectively demonstrate the role played by the concentration of carbon defects on the carbon-polymer films in guiding Li nucleation and the initial deposition process.

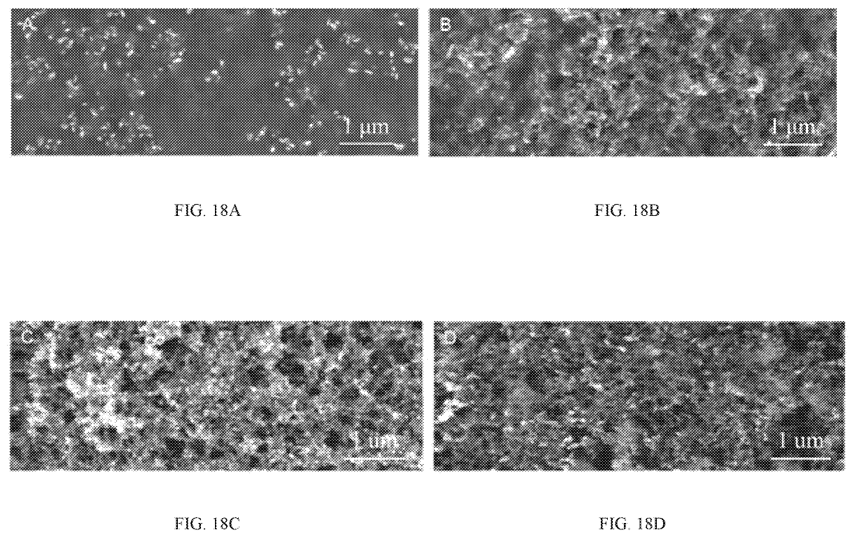

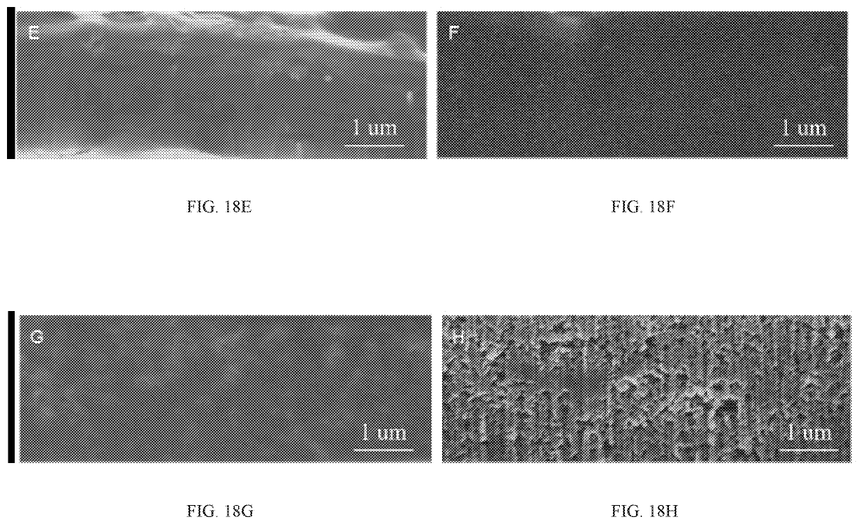

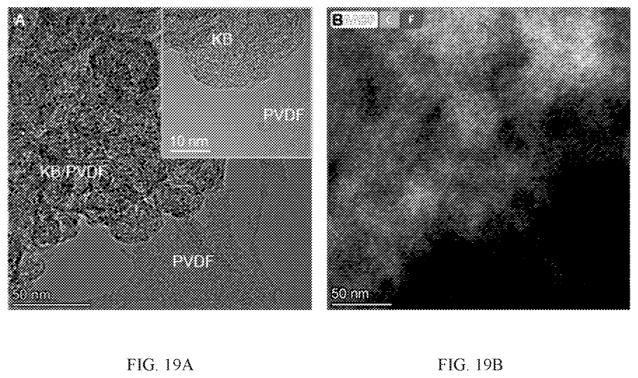

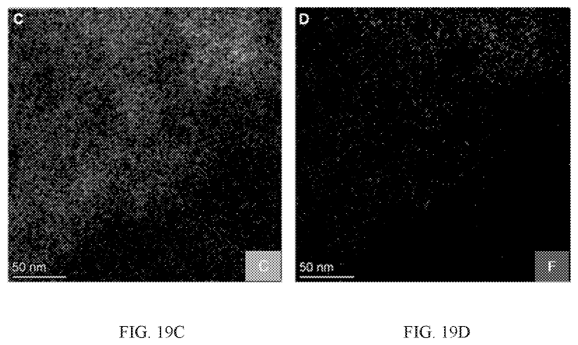

Furthermore, the influence of the gap between carbon particles were investigated by adjusting the carbon ratio in the following carbon-polymer films: KB-5 film, KB-20 film, KB-30 film, and KB-50 film. The top-view and cross-sectional scanning electron microscopy (SEM) images of the films are presented in FIG. 18A-18H. KB-5 and KB-20 films exhibited low porosity, resembling dense polymer films. This observation suggested that the film's effect on Li nucleation primarily depends on the exposed carbon on the surface layer. However, it is worth noting, the PVDF does not completely coat the carbon surface conformally but instead connects the carbon particles, for example, as shown in FIGS. 19A-19D. The morphology and the structure of the carbon particles in the KB-20 film are shown in FIGS. 19A-19D. Increasing the carbon ratio thus exposes more carbon (including defects) on the surface. To gain further insights into the distribution of carbon defects on the ketjen black films, conductive atomic force microscopy (C-AFM) was used to map the conductivity distribution (see FIGS. 3G to 3J). As shown in FIGS. 3G to 3J, the gold-colored regions represent high electronic conductivity, while the brown-colored regions indicate low electronic conductivity. As the carbon ratio increases from 5 wt % to 50 wt %, the distribution uniformity of carbon improves. Interestingly, the mode of Li deposition changes on the KB-30 film and on the KB-50 film. On the KB-30 film, the median size of Li seeds increases from 1.3 μm to 2 μm. When the carbon ratio reaches 50 wt %, Li deposition prefers to occur as connected planar Li structures rather than growing as individual hexagons on the surface. Further, FIGS. 3K-3N are SEM images of the Li deposited on the ketjen black films of FIGS. 3G-3J. It is suggested that the variation in the deposition mode is related to the gap between nucleation sites (carbon defects).

To investigate the relationship between the gap and deposition mode, a simple structural model of a film was constructed, assuming that ketjen black carbon particles pack in an ideal cubic arrangement, where the carbon and PVDF densities were 2 g cm⁻³ and 1.76 g cm⁻³, respectively. As shown in FIG. 3O, theoretically, the gaps between two KB particles in KB-5, KB-20, KB-30, and KB-50 films were 38 nm, 13 nm, 8 nm, and 1 nm, respectively. In KB-5 and KB-20 films, the gap between two nucleation sites was relatively large (>13 nm), resulting in a significant diffusion barrier for Li atoms and Li clusters. Consequently, as schematically shown in FIG. 3I, Li tended to locally nucleate as hexagons. At this stage, the size of Li seeds, approximately 1.5 μm, remained independent of the size of the gap. However, when the gap decreased to less than 8 nm, the gap between two nucleation sites began to affect the mode of Li nucleation. This is because more Li atoms/clusters can merge to form larger hexagons in the earlier stage of seed growth.

### Example 4: Confirmation of Defects as Nucleation Sites

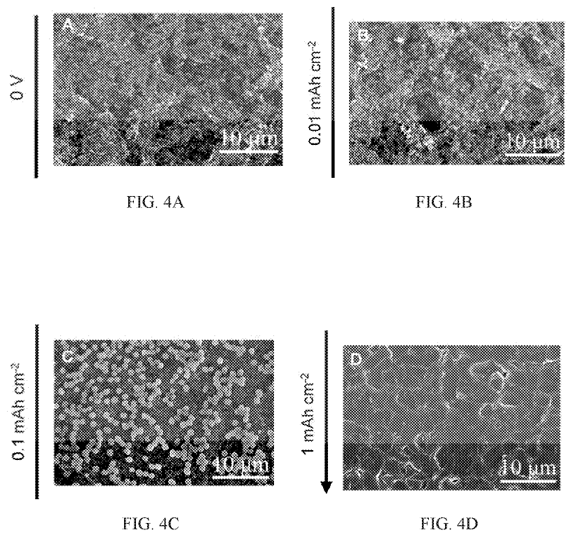

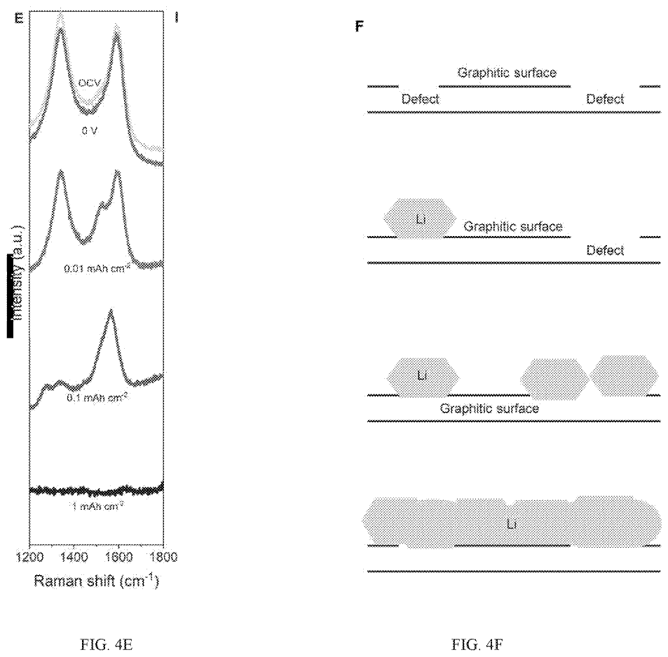

KB-20 film was selected as the model system to investigate the role of carbon defects during Li nucleation. Li|KB-20 film half-cells were discharged to a designed voltage or capacity, and the KB-20 electrodes (KB-20 film on copper foil) were then characterized using scanning electron microscopy (SEM) (see FIGS. 4A-D) and Raman spectroscopy (see FIG. 4E). The Raman spectra of KB-20 at 0 V and at the open-circuit potential appeared similar, and no noticeable solid-electrolyte interphase (SEI) formation could be observed through SEM (see FIG. 4A). After depositing 0.01 mAh cm⁻² of Li, no distinct Li particles were found (see FIG. 4B). However, a new Raman peak appeared near the G band, which can be attributed to carbon lithiation. Upon depositing 0.1 mAh cm⁻² of Li, uniform Li seeds were observed on the surface of KB-20 (see, FIG. 4C), and the D band disappeared while the G band broaden, indicating Li nucleation on carbon defects. After depositing 1 mAh cm⁻² of Li, the KB-20 surface was covered by a compact layer of Li (FIG. 4D), and both the D band and G band had vanished. These findings support that the defects in pure carbon particles can serve as nucleation sites, and a well-distributed presence of carbon defects can result in generally uniform Li nucleation (see FIGS. 1B, 1C and 4F).

### Example 5: Film Effect on the Cycle Life of LMBs—Half Cells

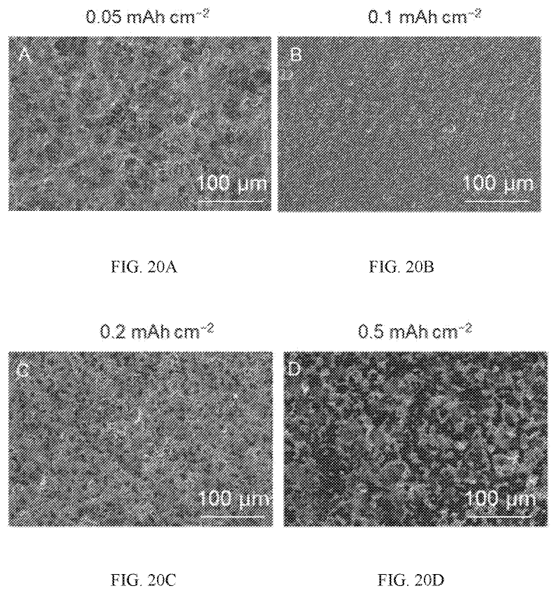

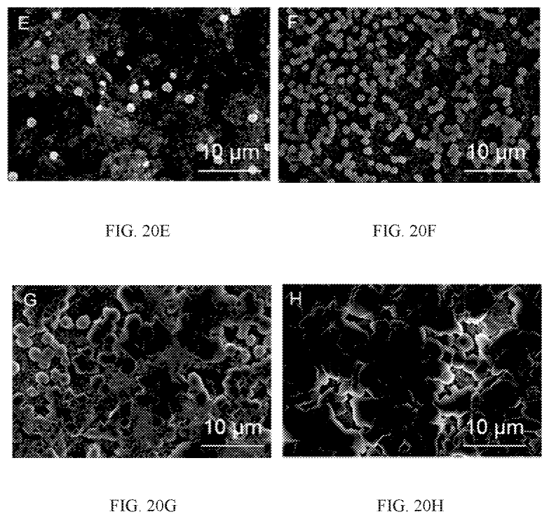

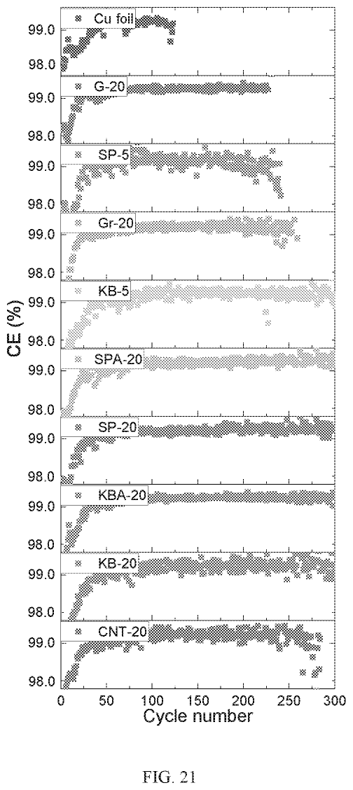

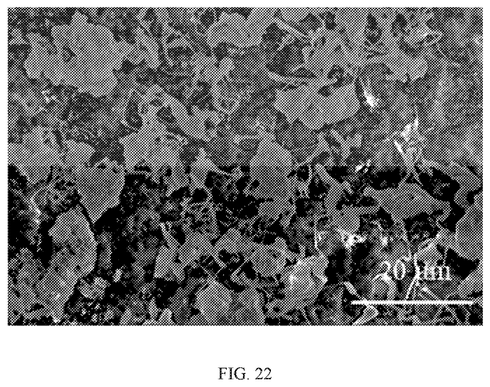

The foregoing experiments demonstrated that surfaces rich in carbon defects facilitate uniform Li nucleation and initial deposition, for example, as shown FIGS. 20A-20, which are SEM images of KB-20 film on copper foil. In theory, a low-porosity morphology should result in superior cycling performance. To evaluate this, the coulombic efficiency (CE) and cycle life of Cu foil, G-20 film, SP-5 film, Gr-20 film, KB-5 film, SPA-20 film, SP-20 film, KBA-20 film, KB-20 film and CNT-20 were examined at a current density of 3 mA cm⁻² and an areal capacity of 3 mAh cm⁻² using the LDME electrolyte, as shown in FIG. 21. All tests involved Li deposition, followed by stripping until the electrode potential reached 1 V. While all films exhibited a similar CE of approximately 99.1%, their cycle life varied from 100 cycles to 300 cycles.

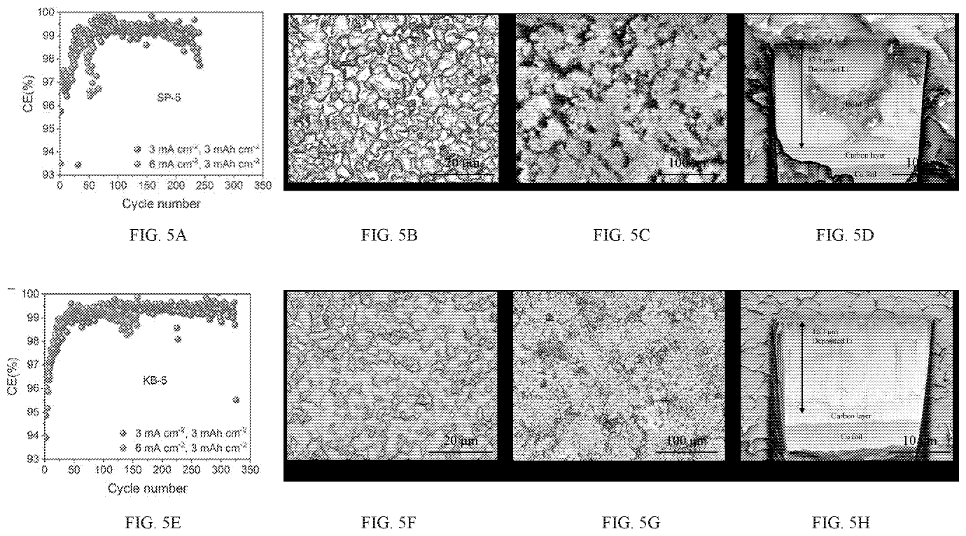

As a case study, a SP-5 film and a KB-5 were focused on at two different current densities, 3 mA cm⁻² and 6 mA cm⁻², each at a capacity of 3 mAh cm⁻². As shown in FIG. 5A, the CE and cycle life of the SP-5 film were found to be 99.0% and 241 cycles, respectively, while the KB-5 film, as shown in FIG. 5E, exhibited a CE of 99.2% and a cycle life of 325 cycles. The initial Li morphologies (0.1 mAh cm⁻²) on these two films were dramatically different. SP-5 showed dendritic Li morphology (see FIG. 22), while KB-5 exhibited uniform hexagonal Li deposition (see FIG. 3K). The Li morphology after the first electrodeposition of 3 mAh cm⁻² of Li were then examined. Although the individual Li particle morphologies were similar, the porosity of Li on the KB-5 film (see FIG. 5F) is lower than that on the SP-5 film (see FIG. 5B). Furthermore, the difference in the uniformity of deposited Li between SP-5 and KB-5 films became more pronounced after 20 cycles. The SP-5 film exhibited random accumulation of dead Li/SEI between the deposited Li, with a total thickness of 17.5 μm (see FIG. 5C and FIG. 5D). In contrast, the KB-5 film maintained a compact Li deposition without noticeable dead Li accumulation, with a total thickness of 15.1 μm (see FIG. 5G and FIG. 5H), which closely matches the ideal thickness of 3 mAh cm⁻² of Li (14.6 μm).

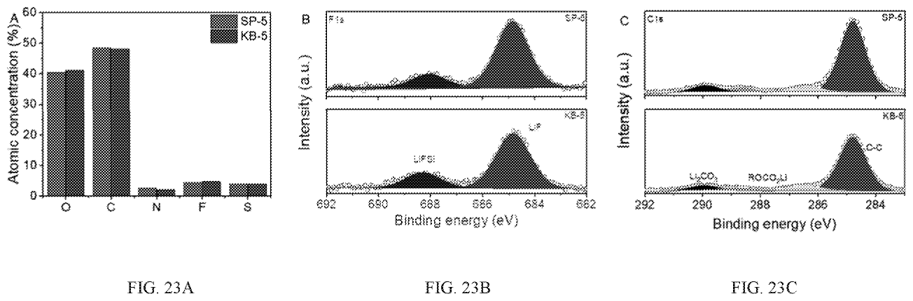

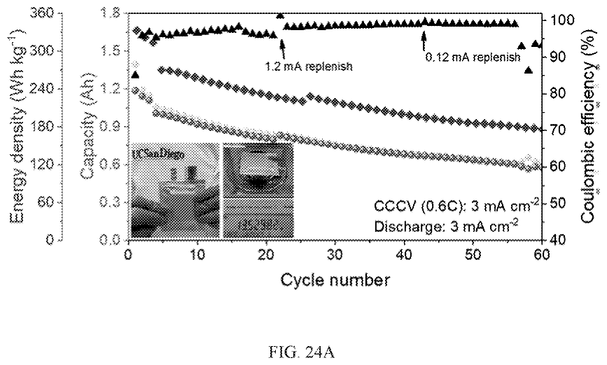

XPS analysis of the SEI layers on both electrodes after 20 cycles revealed similar compositions with nearly the same ratios of O, C, N, F, and S (see FIGS. 23A-23C). These results indicate that the CE of the Li anode was primarily affected by the SEI (electrolyte), while the cycle life depends on the porosity/uniformity of the deposited Li. To further support this position, Li|SP-5 and Li|KB-5 film half-cells were investigated at a current density of 6 mA cm⁻² and an areal capacity of 3 mAh cm⁻². These half-cells had the same configuration as the exemplary half cell 300 of FIG. 28. The Li|SP-5 film cell lasted 50 cycles before failing (see FIG. 5A). In contrast, the Li|KB-5 film cell lasted over 158 cycles with an average CE exceeding 99% after 20 cycles (see FIG. 5E). This observed improvement at such a high current density shows the possibility for fast charging batteries.

### Example 6: Film Effect on the Cycle Life of LMBs-Full Cells

The performance of films rich in carbon defects in full cells were investigated where the full cells included a LiNi_{0.8}Mn_{0.1}Co_{0.1}O₂ (NMC811) cathode with a 4.5 mAh cm⁻² areal capacity and an anode of either Cu foil or a carbon-polymer film with pre-deposited Li (4 mAh cm⁻²), under a lean electrolyte condition of 3 g Ah⁻¹ (~12 μL per coin cell). The carbon-polymer film included 20 weight percent ketjen black (KB-20 film). This set up corresponds to an N/P ratio of 0.89. Additionally, the full cells were cycled for one hour at a 1 C rate, corresponding to a current density of approximately 4.5 mA cm⁻².

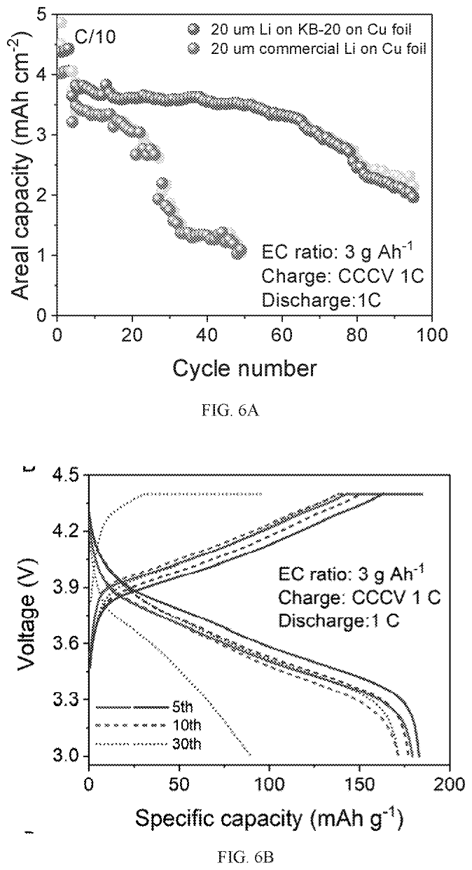

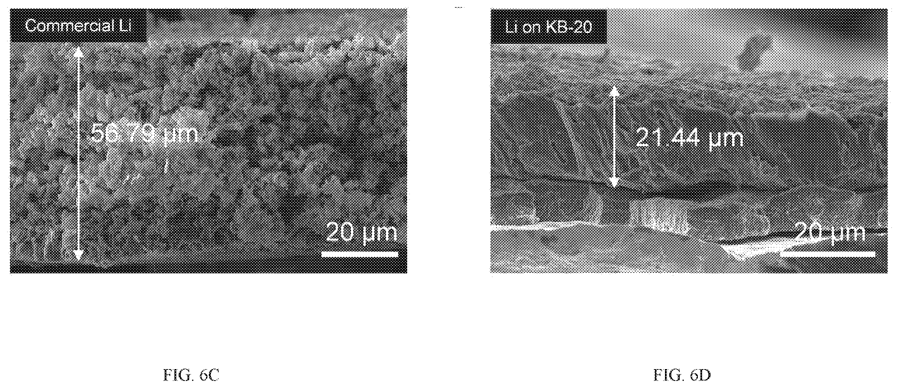

FIG. 6A illustrates the cycling performance of the full cells. The Cu cell lasted only 20 cycles before experiencing rapid degradation. The cell capacity decayed from >3.5 mAh cm⁻² to approximately 1.2 mAh cm⁻² within a few cycles. This degradation pattern is similar to that observed in reported lean-electrolyte cells, which can be attributed to electrolyte depletion. In contrast, the cell with KB-20 film demonstrated stable cycling for 60 cycles until all pre-deposited Li is depleted, after which it maintained a CE of ~99.2%. The voltage profile, as shown in FIG. 6B, also indicates that the presence of KB-20 leads to a slower evolution of Li anode impedance.

To gain insight into the underlying mechanisms for the significant difference in cyclability, the cells were disassembled after 20 cycles to examine the morphology of Li. On the KB-20 film, the Li maintained a compact structure (see FIG. 6D). In contrast, the Li on Cu foil exhibited an extremely porous and mossy morphology (see FIG. 6C). The Li layer thickness on KB-20 film was 21.44 μm including ~2 μm thick SEI layer on the top surface, while on Cu foil it was 56.79 μm. These findings are consistent with the evaluations conducted in half-cells (see FIG. 5D and FIG. 5H), indicating that the film effect persists even under full cell conditions.

An anode-free design was also investigated. A KB-20 film on copper foil was used as the anode and was evaluated in a 1.2 Ah pouch cell, paired with an NMC811 cathode (5 mAh cm⁻²), under a lean electrolyte condition of 3 g Ah⁻¹ (3.6 g per pouch cell), where the electrolyte was LDME. To mitigate the issue of lithium loss due to initial carbon lithiation, a 100 μm thick Li foil (0.24 Ah) was electronically connected (e.g., allowing electron transfer) to the bottom layer of the KB-20 electrode (see FIG. 24B). More specifically, the Li foil was directly attached to the second film of the anode that was at the bottom of the stack. Both the cathode (see FIGS. 26A and 26B) and the anode (see FIGS. 25A-25F) were modified with a pore array using a laser cutter to facilitate better initial lithiation. The pore size was approximately 30 μm, with a gap of 3.2 mm (equivalent to 0.125 inch) between two pores. More specifically, as shown in FIGS. 25A-25C the copper foil includes the pore array and as shown in FIGS. 25D-25F, the KB-20 film is deposited onto the copper foil. The test pouch cell had a structural configuration that was similar to pouch cell 400 of FIG. 29. During normal operation, it was expected that the cell would function as an “anode free” cell. The Li layer does not participate in the battery operation due to the long diffusion paths. However, this design allowed for replenishing active lithium by slowly discharging the cathode when the lithium metal anode on the back of the anode becomes active. With consideration of the total mass of the pouch cell, which in this experiment was 13.52982 g, as shown in FIG. 24A, a pouch cell with an energy density of 330 Wh kg⁻¹ was achieved. Based on the mass of the active stack and electrolyte, the pouch cell achieved a projected energy density of 393 Wh kg⁻¹. After sealing the cell, the cell was rested to ensure proper electrolyte wetting and the autonomous lithiation of the anode by the lithium metal foil.

The cell then underwent initial formation cycles at C/10 for three cycles. As shown in FIG. 24A, the first three coulombic efficiencies (CEs) were measured at 85%, 95.9%, and 96.8%, respectively, which align with the foregoing half-cell tests. The initial CE of the KB-20 film tested in a half cell was only 90% (see FIG. 21), indicating that the excess Li provided by the initial irreversible capacity of the cathode was consumed by the irreversible reaction on the KB-20 film. Therefore, the CE of the pouch cell was primarily determined by the reversibility of Li on the KB-20 film. Subsequently, as shown in FIG. 24A, the NMC811 pouch cell was cycled at a 0.6 C rate, corresponding to a current density of 3 mA cm⁻² (equivalent to 0.72 A). To mitigate the rate of capacity decay, starting from Cycle 22, an additional constant current of 1.2 mA discharge was introduced to slowly replenish Li from the bottom Li foil after the 0.6 C discharge step. The current for Li replenishment was reduced to 0.12 mA after Cycle 43. Ultimately, the pouch cell lasted for 57 cycles, achieving a CE of 99.1% before experiencing a soft short. The pouch cell surpasses the performance of the coin cells, exhibiting a substantial 2.8 times improvement in cycle life after the pre-deposited lithium was depleted (see FIG. 6A). This 1.2 Ah pouch cell demonstrated that the film effect persists under practical cell conditions.

Although various illustrative implementations are described above, any of a number of changes can be made to various implementations without departing from the teachings herein. For example, the order in which various described method steps are performed can often be changed in alternative implementations, and in other alternative implementations, one or more method steps can be skipped altogether. Optional features of various system and process implementations can be included in some implementations and not in others. Therefore, the foregoing description is provided primarily for exemplary purposes and should not be interpreted to limit the scope of the claims.

The examples and illustrations included herein show, by way of illustration and not of limitation, specific implementations in which the subject matter can be practiced. As mentioned, other implementations can be utilized and derived there from, such that structural and logical substitutions and changes can be made without departing from the scope of this disclosure. Such implementations of the inventive subject matter can be referred to herein individually or collectively by the term “invention” merely for convenience and without intending to voluntarily limit the scope of this application to any single invention or inventive concept, if more than one is, in fact, disclosed. Thus, although specific implementations have been illustrated and described herein, any arrangement calculated to achieve the same purpose can be substituted for the specific implementations shown. This disclosure is intended to cover any and all adaptations or variations of various implementations. Combinations of the above implementations, and other implementations not specifically described herein, will be apparent to those of skill in the art upon reviewing the above description. Use of the term “based on,” herein and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with implementations related to the described subject matter. Although a few variations have been described in detail herein, other modifications or additions are possible. In particular, further features and/or variations can be provided in addition to those set forth herein. For example, the implementations described herein can be directed to various combinations and subcombinations of the disclosed features and/or combinations and subcombinations of several further features disclosed herein. In addition, the logic flows depicted in the accompanying figures and/or described herein do not necessarily require the particular order shown, or sequential order, to achieve desirable results. Other implementations can be within the scope of the following claims.

1. A lithium metal battery, comprising:
a cathode;
a negative current collector comprising a carbon-polymer film, the film comprising carbon particles and one or more polymers, wherein the carbon particles are present in the film in an amount of about 30 weight percent or lower and the carbon particles have a ID/IG ratio of about 1 or greater, and wherein at least a portion of the total amount of carbon particles are present at an outer-most surface of the film;
an anode comprising a plurality of faceted lithium seeds, wherein the plurality of faceted lithium seeds are on a surface of exposed carbon defects of the carbon particles present at the outer-most surface of film;
one or more separators positioned between the anode and the cathode; and
one or more electrolytes, wherein an amount of the one or more electrolytes is positioned between the cathode and at least one separator of the one or more separators and another amount of the one or more electrolytes is positioned between the anode and the at least one separator of the one or more separators.

2. The lithium metal battery of claim 1, further comprising a base substrate comprising one or more conductive materials, wherein the film is on a surface of the base substrate.

3. The lithium metal battery of claim 2, wherein the one or more conductive materials comprise copper, stainless steel, silver, gold, zinc, aluminum, tungsten, nickel, iron, titanium, alloys thereof, or any combination thereof.

4. The lithium metal battery of claim 1, wherein the one or more polymers are present in the film in an amount of about 70 weight percent or greater.

5. The lithium metal battery of claim 4, wherein the one or more polymers are present in the film in an amount of about 95 weight percent or greater

6. The lithium metal battery of claim 1, wherein the carbon particles are present in the film in an amount from about 1 weight percent to about 30 weight percent.

7. The lithium metal battery of claim 6, wherein the carbon particles are present in the film in an amount from about 5 weight percent to about 20 weight percent.

8. The lithium metal battery of claim 6, wherein the carbon particles are present in the film in an amount of about 20 weight percent.

9. The lithium metal battery of claim 1, wherein the ID/IG ratio of the carbon particles is from about 1 to about 2.

10. The lithium metal battery of claim 9, wherein the ID/IG ratio of the carbon particles is from about 1 to about 1.5.

11. The lithium metal battery of claim 9, wherein the ID/IG ratio of the carbon particles is from about 1.01 to about 1.29.

12. The lithium metal battery of claim 9, wherein the ID/IG ratio of the carbon particles is about 1.2 or greater.

13. The lithium metal battery of claim 1, wherein at least two carbon particles present in the film are spaced apart at a distance from each other, the distance being from about 1 nm to about 100 nm.

14. The lithium metal battery of claim 13, wherein at least two carbon particles present in the film are spaced apart at a distance from each other, the distance being from about 1 nm to about 38 nm.

15. The lithium metal battery of claim 13, wherein at least two carbon particles present in the film are spaced apart at a distance from each other, the distance being from about 8 nm to about 38 nm.

16. The lithium metal battery of claim 13, wherein at least two carbon particles present in the film are spaced apart at a distance from each other, the distance being from about 10 nm to about 40 nm.

17-43. (canceled)

44. A negative electrode, comprising:
a carbon-polymer film comprising carbon particles and one or more polymers, wherein the carbon particles are present in the film in an amount of about 30 weight percent or lower and the carbon particles have a ID/IG ratio of about 1 or greater, and wherein at least a portion of the total amount of carbon particles are present at an outer-most surface of the film; and
a plurality of faceted lithium seeds on a surface of exposed carbon defects of the carbon particles present at the outer-most surface of film.

45. The negative electrode of claim 44, further comprising a base substrate comprising one or more conductive materials, wherein the film is on a surface of the base substrate.

46-80. (canceled)

81. A method of manufacturing a negative electrode, the method comprising:
mixing carbon particles, one or more polymers, and one or more solvents to form a slurry;
drying the slurry to remove the one or more solvents to form a carbon-polymer film, wherein the carbon particles are present in the film in an amount of about 30 weight percent or lower and the carbon particles have a ID/IG ratio of about 1 or greater, wherein at least a portion of the total amount of carbon particles are present at an outer-most surface of the film; and
exposing the film to electrical current such that a plurality of faceted lithium seeds nucleate on a surface of exposed carbon defects of the carbon particles present at the outermost surface of the film.

82-108. (canceled)

109. A method of manufacturing a lithium metal battery, the method comprising:
providing a negative current collector, the negative current collector comprising a carbon-polymer film, the film comprising,
carbon particles and one or more polymers, wherein the carbon particles are present in the film in an amount of about 5 weight percent or greater and the carbon particles have a ID/IG ratio of about 1 or greater; wherein at least a portion of the total amount of carbon particles are present at an outer-most surface of the film;
providing a cathode on a positive current collector;
applying one or more electrolytes to a separator;
positioning a first surface of a separator adjacent to the cathode, wherein an amount of the one or more electrolytes is positioned between the separator and the cathode;
positioning the negative current collector adjacent a second, opposing surface of the separator; wherein another amount of the one or more electrolytes is positioned between the separator and the negative current collector; and
exposing the negative current collector to electrical current such that a plurality of faceted lithium seeds nucleate on a surface of exposed carbon defects of the carbon particles present at the outer-most surface of the film.

110-148. (canceled)
